(19) United States
(12) Patent Application Publication
(10) Pub. No.: US 2023/0076104 A1
(43) Pub. Date: Mar. 9, 2023

(54) CROP PHENOLOGY CHARACTERIZATION METHOD, AND SYSTEM USING SAME

(71) Applicant: SemiosBio Technologies Inc., Vancouver (CA)

(72) Inventors: Jordan Richard Hazell, Dunnville (CA); Johann David Martinez, Davis, CA (US); Michael Walter Gilbert, Vancouver (CA); Kenny Ka Hin Leung, Burnaby (CA); Tomas Teitelbaum, Vancouver (CA)

(21) Appl. No.: 17/896,935

(22) Filed: Aug. 26, 2022

Related U.S. Application Data
(60) Provisional application No. 63/237,430, filed on Aug. 26, 2021.

(51) Int. Cl. A01B 79/00; A01B 79/02; G01B 7/12

(52) U.S. Cl. CPC A01B 79/005; A01B 79/02; G01B 7/12

(57) ABSTRACT

Described are various embodiments of a crop phenology characterisation method, and system using same. One embodiment relates to a method of monitoring a crop phenology, the method comprising acquiring a size measurement of a crop in a crop location over time, monitoring a first parameter calculated based at least in part on to a periodic recovery value of the size measurement, and a second parameter calculated at least in part based on a periodic growth value of the size measurement. In some embodiments, one or more of the first parameter and the second parameter are indicative of a crop characteristic. In some embodiments, an indication related to the crop characteristic may be provided in response to one or more of the first parameter and the second parameter.

### FIELD OF THE DISCLOSURE

The present disclosure relates to crop management, and, in particular, to a crop phenology characterisation method, and system using same.

### BACKGROUND

Improved crop management practices may lead to improved crop outcomes, ultimately benefiting a grower in terms of a return on investment. For instance, appropriate timing of pesticide applications with pest phenologies may ultimately improve crop outcomes. Similarly, the efficient use of water can reduce the costs associated with irrigating a crop, without necessarily sacrificing the quality or value of the crop upon sale. Accordingly, various disclosures relate to the assessment of a crop status or stress level to determine an appropriate volume or timing of an irrigation in response to a measured crop property.

For instance, U.S. Pat. No. 10,631,474 entitled “Method and System for Treating Crop According to Predicted Yield” and issued to Guy, et al. on Apr. 28, 2020 discloses a method of operating a crop treatment system in response to dendrometer measurements of crop size. However, extracted data is limited to a daily growth value and a maximum daily shrinkage (MDS), wherein measured values are coarsened by a plant status function that ultimately encourages irrigation when it is deemed that a crop is underwatered. Such disclosures do not characterise a crop phenology, the accurate assessment of which may be used to better inform crop management practices.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a crop phenology characterisation method, and system using same that overcome some of the drawbacks of known techniques, or at least, provides a useful alternative thereto. Some aspects of this disclosure provide examples of such systems and methods.

In accordance with one aspect, there is provided a method of monitoring a crop phenology, the method comprising: acquiring a size measurement of a crop in a crop location over time; monitoring a first parameter calculated based at least in part on to a periodic recovery value of the size measurement, and a second parameter calculated at least in part based on a periodic growth value of the size measurement, wherein one or more of the first parameter and the second parameter are indicative of a crop characteristic; and providing an indication related to the crop characteristic in response to one or more of the first parameter and the second parameter.

In one embodiment, the crop characteristic is related to a phenological crop growth stage.

In one embodiment, the phenological crop growth stage is related to a crop lag phase.

In one embodiment, the first parameter is indicative of one or more of a beginning or an end of the crop lag phase.

In one embodiment, the crop characteristic is related to a crop ripening stage.

In one embodiment, the first parameter is indicative of a beginning of a crop ripening phase.

In one embodiment, the second parameter is indicative of a midpoint of the plant ripening phase.

In one embodiment, the method further comprises calculating, based at least in part on a phenological model, a predicted crop ripeness parameter for a future time, wherein the predicted crop ripeness parameter is related to the crop characteristic and the indication is provided in response to at least one of the first parameter, the second parameter, or the predicted crop ripeness parameter.

In one embodiment, the method further comprises updating the phenological model based at least in part on a current crop ripeness parameter measured in accordance with a designated time associated with one or more of the first parameter or the second parameter.

In one embodiment, the method further comprises monitoring a third parameter related to an extremum of the size measurement over the at least a portion of a growth season, wherein the third parameter is indicative of the crop characteristic, and wherein the indication is provided in response to one or more of the first, second, or third parameter.

In one embodiment, the indication relates to one or more of a yield estimation, a harvest time, an irrigation recommendation, or a crop ripeness.

In one embodiment, the first parameter is calculated as a function of the product of a designated number of the periodic recovery values.

In one embodiment, the first parameter is calculated as a function of the product of the inverse of a designated number of periodic growth values.

In one embodiment, the second parameter is calculated as a function of the product of a designated number of the daily growth values.

In one embodiment, the periodic recovery value relates to an increase in the size measurement over time as compared to a periodic minimum of the size measurement.

In one embodiment, the periodic recovery value is limited to a maximum recovery value calculated as a function of a periodic maximum and the periodic minimum of the size measurement.

In one embodiment, the method further comprises generating a crop treatment recommendation based at least in part on one or more of the first or second parameter.

In one embodiment, the method further comprises operating a crop treatment system based at least in part on the first or second parameter.

In one embodiment, the method further comprises providing a crop treatment scheme based at least in part on respective first and second parameters corresponding to respective crop locations.

In one embodiment, the size measurement is acquired using a dendrometer.

In one embodiment, the monitoring further comprises monitoring an environmental parameter, and wherein the indication is provided at least in part based on the environmental parameter.

In one embodiment, the periodic values comprise daily values or weekly values.

In one embodiment, the crop characteristic comprises one or more of a predicted crop yield or a crop grade.

In accordance with another aspect, there is provided a method of monitoring a crop phenology, the method comprising acquiring a size measurement of a crop in a crop location over time, monitoring a first parameter calculated based at least in part on to a periodic shrinkage value of the size measurement, and a second parameter calculated at least in part based on a periodic growth value of the size measurement, wherein one or more of the first parameter and the second parameter are indicative of a crop characteristic, and providing an indication related to the crop characteristic in response to one or more of the first parameter and the second parameter.

In one embodiment, the crop characteristic is related to a phenological crop growth stage.

In one embodiment, the phenological crop growth stage is related to a crop lag phase.

In one embodiment, the first parameter is indicative of one or more of a beginning or an end of the crop lag phase.

In one embodiment, the crop characteristic is related to a crop ripening stage.

In one embodiment, the first parameter is indicative of a beginning of a crop ripening phase.

In one embodiment, the second parameter is indicative of a midpoint of the plant ripening phase.

In one embodiment, the method further comprises calculating, based at least in part on a phenological model, a predicted crop ripeness parameter for a future time, wherein the predicted crop ripeness parameter is related to the crop characteristic and the indication is provided in response to at least one of the first parameter, the second parameter, or the predicted crop ripeness parameter.

In one embodiment, the method further comprises updating the phenological model based at least in part on a current crop ripeness parameter measured in accordance with a designated time associated with one or more of the first parameter or the second parameter.

In one embodiment, the method further comprises monitoring a third parameter related to an extremum of the size measurement over the at least a portion of a growth season, wherein the third parameter is indicative of the crop characteristic, and wherein the indication is provided in response to one or more of the first, second, or third parameter.

In one embodiment, the indication relates to one or more of a yield estimation, a harvest time, an irrigation recommendation, or a crop ripeness.

In one embodiment, the first parameter is calculated as a function of the product of a designated number of the periodic shrinkage values.

In one embodiment, the first parameter is calculated as a function of the product of the inverse of a designated number of periodic growth values.

In one embodiment, the second parameter is calculated as a function of the product of a designated number of the daily growth values.

In one embodiment, the periodic shrinkage value relates to an increase in the size measurement over time as compared to a periodic minimum of the size measurement.

In one embodiment, the periodic shrinkage value is limited to a maximum shrinkage value calculated as a function of a periodic maximum and the periodic minimum of the size measurement.

In one embodiment, the method further comprises generating a crop treatment recommendation based at least in part on one or more of the first or second parameter.

In one embodiment, the method further comprises operating a crop treatment system based at least in part on the first or second parameter.

In one embodiment, the method further comprises providing a crop treatment scheme based at least in part on respective first and second parameters corresponding to respective crop locations.

In one embodiment, the size measurement is acquired using a dendrometer.

In one embodiment, the monitoring further comprises monitoring an environmental parameter, and wherein the indication is provided at least in part based on the environmental parameter.

In one embodiment, the periodic values comprise values corresponding to a daily or a weekly time scale.

In one embodiment, the crop characteristic comprises one or more of a predicted crop yield or a crop grade.

In accordance with another aspect, there is provided a system for monitoring a crop phenology, the system comprising a crop sensor operable to acquire crop size data of a crop in a crop location over time, a digital data processor operable on the crop size data to calculate a first parameter based at least in part on to a periodic recovery value and a second parameter at least in part based on a periodic growth value, wherein one or more of the first parameter and the second parameter are indicative of a crop characteristic, and an indicator system configured to provide an indication related to the crop characteristic in response to one or more of the first parameter and the second parameter.

In one embodiment, the crop characteristic is related to a phenological crop growth stage.

In one embodiment, the phenological crop growth stage is related to a crop lag phase.

In one embodiment, the first parameter is indicative of one or more of a beginning or an end of the crop lag phase.

In one embodiment, the crop characteristic is related to a crop ripening stage.

In one embodiment, the first parameter is indicative of a beginning of a crop ripening phase.

In one embodiment, the second parameter is indicative of a midpoint of the plant ripening phase.

In one embodiment, the system further comprises a digital data storage device configured for storing the crop size data over time and having stored thereon a phenological model, wherein the digital data processor is further operable to calculate at least in part based on the phenological model a predicted crop ripeness parameter for a future time, wherein the predicted crop ripeness parameter is related to the crop characteristic, and wherein the indication is provided in response to at least one of the first parameter, the second parameter, or the predicted crop ripeness parameter.

In one embodiment, the digital data processor is further operable to update the phenological model based at least in part on a current crop ripeness parameter measured in accordance with a designated time associated with one or more of the first parameter or the second parameter.

In one embodiment, the digital data processor is further operable to calculate a third parameter related to an extremum of the crop size data over the at least a portion of a growth season, wherein the third parameter is indicative of the crop characteristic, and wherein the indication is provided in response to one or more of the first, second, or third parameter.

In one embodiment, the first parameter is calculated as a function of the product of a designated number of the periodic recovery values.

In one embodiment, the first parameter is calculated as a function of the product of the inverse of a designated number of periodic growth values.

In one embodiment, the second parameter is calculated as a function of the product of a designated number of the daily growth values.

In one embodiment, the periodic recovery value relates to an increase in the size measurement over time as compared to a periodic minimum of the size measurement.

In one embodiment, the periodic recovery value is limited to a maximum recovery value calculated as a function of a periodic maximum and the periodic minimum of the size measurement.

In one embodiment, the digital data processor is further operable to generate a crop treatment recommendation based at least in part on one or more of the first or second parameter.

In one embodiment, the system further comprises a crop treatment system operable to apply a crop treatment based on the crop treatment recommendation.

In one embodiment, the digital data processor is further operable to provide a crop treatment scheme based at least in part on respective first and second parameters corresponding to respective crop locations.

In one embodiment, the crop sensor comprises a dendrometer.

In one embodiment, the system further comprises an environmental sensor configured to acquire environmental data.

In one embodiment, one or more of the first parameter or the second parameter is calculated based at least in part on the environmental data.

In one embodiment, the digital data processor is further operable to monitor an environmental parameter based at least in part on the environmental data, and wherein the indication is provided at least in part based on the environmental parameter.

In accordance with another aspect, there is provided a system of monitoring a crop phenology, the system comprising a crop sensor operable to acquire crop size data of a crop in a crop location over time, a digital data processor operable on the crop size data to calculate a first parameter based at least in part on to a periodic recovery value and a second parameter at least in part based on a periodic growth value, wherein one or more of the first parameter and the second parameter are indicative of a crop characteristic, and an indicator system configured to provide an indication related to the crop characteristic in response to one or more of the first parameter and the second parameter.

In accordance with another aspect, there is provided a method of monitoring a crop phenology, the method comprising acquiring a size measurement of a crop in a crop location over time; monitoring a first parameter periodically calculated based at least in part on a periodic maximum value and a plurality of previously acquired periodic maximum values of the size measurement acquired within a designated time window, and a second parameter calculated at least in part based on the first parameter and a periodic minimal value of the size measurement, the second parameter being indicative of a crop characteristic; and providing an indication related to the crop characteristic in response to the second parameter.

In one embodiment, the method comprises calculating, using a digital data processor configured to receive as input the size measurement acquired over time, a crop growth parameter corresponding at least in part to a characteristic periodic value of the size measurement, wherein the second parameter is calculated at least in part based on the crop growth parameter.

In one embodiment, the first parameter is calculated at least in part based on the crop growth parameter.

In one embodiment, the characteristic periodic value corresponds to one or more of a daily maximum or a daily minimum of the size measurement acquired over time.

In one embodiment, the crop growth parameter is calculated at least in part based on a plurality of previously calculated crop growth parameters corresponding to a designated historical crop growth time window.

In one embodiment, the method further comprises digitally adjusting one or more of the first or second parameter by a designated adjustment value corresponding at least in part to the crop growth parameter.

In one embodiment, the method further comprises calculating, using a digital data processor configured to receive as input the second parameter, indicative of the crop characteristic, and a normalisation parameter corresponding at least in part to a comparable crop associated with a designated crop characteristic, a normalised second parameter indicative at least in part of the crop characteristic of the crop relative to the designated crop characteristic.

In one embodiment, the plurality of previously acquired periodic maximum values comprises a subset of periodic maximum values acquired within the designated historical time window.

In one embodiment, the method further comprises digitally performing, using a digital data processor, a comparison of a current value of the first parameter with a previous value of the first parameter calculated over a designated seasonal time window, and, based at least in part on a result of the comparison, digitally updating the first parameter as the current value of the first parameter.

In one embodiment, the second parameter comprises a difference between the periodically calculated first parameter and the periodic minimal value of the size measurement.

In one embodiment, the size measurement comprises a dendrometer measurement.

In accordance with another aspect, there is provided a system for monitoring a crop phenology, the system comprising a crop sensor configured to acquire crop size data corresponding with a crop in a crop location over time; a digital data processor configured to receive as input the crop size data and periodically calculate a first parameter based at least in part on a periodic maximum value and a plurality of previously acquired periodic maximum values of the crop size data acquired within a designated time window, and a second parameter based at least in part on the first parameter and a periodic minimal value of the crop size data, the second parameter being indicative of a crop characteristic; and an indicator system configured to provide an indication related to the crop characteristic in response to the second parameter.

In one embodiment, the digital data processor is configured to calculate a crop growth parameter corresponding at least in part to a characteristic periodic value of the crop size data, wherein the second parameter is calculated at least in part based on the crop growth parameter.

In one embodiment, the first parameter is calculated at least in part based on the crop growth parameter.

In one embodiment, the characteristic periodic value corresponds to one or more of a daily maximum or a daily minimum of the crop size data acquired over time.

In one embodiment, the crop growth parameter is calculated at least in part based on a plurality of previously calculated crop growth parameters corresponding to a designated historical crop growth time window.

In one embodiment, the digital data processor is configured to digitally adjust one or more of the first or second parameter by a designated adjustment value corresponding at least in part to the crop growth parameter.

In one embodiment, the digital data processor is configured to calculate, based at least in part on input received corresponding to the second parameter, indicative of the crop characteristic, and a normalisation parameter corresponding at least in part to a comparable crop associated with a designated crop characteristic, a normalised second parameter indicative at least in part of the crop characteristic of the crop relative to the designated crop characteristic.

In one embodiment, the plurality of previously acquired periodic maximum values comprises a subset of periodic maximum values acquired within the designated historical time window.

In one embodiment, the digital data processor is configured to execute a comparison of a current value of the first parameter with a previous value of the first parameter calculated over a designated seasonal time window, and, based at least in part on a result of the comparison, digitally update the first parameter as the current value of the first parameter.

In one embodiment, the second parameter comprises a difference between the periodically calculated first parameter and the periodic minimal value of the crop size data.

In one embodiment, the crop sensor comprises a dendrometer.

In accordance with another aspect, there is provided a non-transitory computer-readable medium comprising digital instructions to be implement by a digital data processor to monitor a crop phenology by receiving as input a size measurement of a crop in a crop location over time, monitoring a first parameter calculated based at least in part on to a periodic recovery value of the size measurement, and a second parameter calculated at least in part based on a periodic growth value of the size measurement, wherein one or more of the first parameter and the second parameter are indicative of a crop characteristic, and providing an indication related to the crop characteristic in response to one or more of the first parameter and the second parameter.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is an exemplary plot of an illustrative crop phenology, in accordance with various embodiments;

FIG. 2 is an exemplary plot of an illustrative crop size profile acquired over a portion of a growing season, in accordance with various embodiments;

FIG. 3 is an exemplary plot illustrating various aspects of crop growth phenology, in accordance with various embodiments;

FIGS. 4A to 4D are exemplary plots illustrating daily crop recovery values, in accordance with various embodiments;

FIGS. 5 and 6 are exemplary plots illustrating respective measured grape phenologies and calculated first and second parameters associated therewith, in accordance with various embodiments;

FIGS. 7A to 7C are exemplary plots illustrating crop parameter predictions based at least in part on a crop phenology assessment, in accordance with various embodiments; and

FIG. 8A is an exemplary plot of exemplary crop size data and the monitoring of various exemplary parameters related thereto, FIG. 8B is another exemplary plot of exemplary crop size data, FIG. 8C is a plot of exemplary stem water potential measurements corresponding to the crop of FIG. 8B, and FIG. 8D is exemplary plots of MDS and exemplary second parameter data monitored using the exemplary crop size data of FIG. 8B, in accordance with some embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

It is appreciated by the skilled artisan that the timing of a harvest may have a significant impact on a yield or quality of the harvested crop, even on the time scale of single days. Accordingly, an accurate knowledge of a crop status or phenological growth stage (e.g. a current crop growth stage, a temporal progression therethrough, a crop maturity, a current or predicted crop status, or the like), may allow for more accurate crop management practices through an improved understanding of current and future crop behaviour. This may enable a grower to, for instance, accurately schedule irrigation practices, yield estimates, harvest periods, or the like. For example, and as further described below, an accurate knowledge of a current crop stage may allow for precisely timed yield estimates and/or harvesting times, thereby allowing the grower to appropriately manage resources and hire an appropriate workforce for a well-defined harvest period, ultimately improving, for instance, a monetary return for a crop.

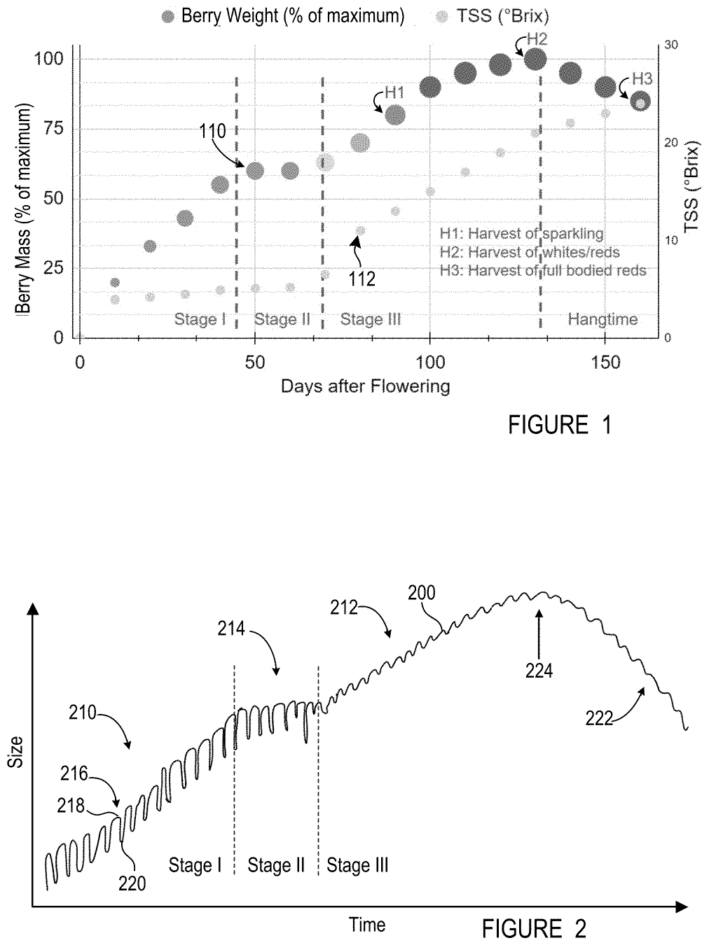

To further illustrate this notion, FIG. 1 is an exemplary plot of a grape phenology as a function of time after fruit set. In this example, and in accordance with various embodiments, grapes are observed to exhibit three characteristic growth stages. Stage I, initiated by fruit set, is typically characterised by berry weight 110 increasing in accordance with an approximately sigmoidal growth profile, wherein berry size increases rapidly before decreasing in growth rate. Stage II, wherein berries begin to ripen (i.e. veraison), is typically characterised by relatively little growth. In Stage III, berries again exhibit approximately sigmoidal growth before reaching their maximum size. After reaching a maximum size, grapes may reduce in size while sugar content continues to rise (i.e. hangtime). FIG. 1 also shows an exemplary curve of the total soluble solids (TSS) 112 (e.g. degrees brix, percentage of sugar, a potential alcohol, or the like) in grapes throughout Stages I to III, wherein the TSS 112 generally rises, but at significantly different rates than the berry weight 110. In Stage III, it can be seen that while the berry weight 110 decreases after reaching a maximum weight, TSS 112 continues to rise. It will be appreciated that while the exemplary metric of TSS 112 is shown in FIG. 1, various other parameters may exhibit similar trends to TSS during crop maturation, and may be a consideration for a grower or crop phenology assessment system or method, in accordance with various embodiments.

Importantly, while some growers may prefer to harvest a grape crop near the maximum berry size (e.g. a grower may prefer to harvest white grapes at harvest time H2 in FIG. 1), different growers, or a grower of different grape varieties, may prefer to harvest crops in accordance with different berry sizes or TSS values. For example, a grower may prefer to harvest young champagne grapes that have a lower TSS content, and may therefore wish to harvest before berries have reached their maximum size (e.g. a grower may prefer to harvest sparkling wine grapes at harvest time H1 in FIG. 1). Conversely, it may be preferred to harvest sweeter grapes that have shrunk in size since a maximum thereof, but have a higher TSS content. In such a case, a grower may harvest at some time after a maximum berry size (e.g. at harvest time H3 in FIG. 1). While this can be achieved with some difficulty by continuously and manually monitoring a TSS content, ascertaining a current phenological stage is challenging without knowledge of, for instance, a future maximum crop size, or an accurate assessment of TSS content. Accordingly, and in accordance with some embodiments, an improved crop management process may comprise accurately assessing a current and/or predicted crop phenological growth stage so to more efficiently plan a harvest.

Interestingly, and as will be appreciated by those skilled in the art, Stage II, also referred to as a “lag phase”, may serve as a reliable stage of grape phenology during which to perform an estimation of a final crop yield. For example, a crop weight estimation during lag phase may be a known fraction (e.g. 40%, 50%, 70%, 80%, etc.) of the maximum berry size observed for a berry growth cycle. For instance, the exemplary plot of berry weight in FIG. 1 shows that the berry weight during lag phase or Stage II is approximately 60% of the maximum berry weight observed during crop maturation. Further, for different crop varieties or types, and/or for preferred harvest times, there may be known relationships between lag phase weights of crops and that yielded at a harvest. For example, a champagne grape may be preferable harvested at 80% of a maximum theoretical berry size, wherein the maximum berry size may in turn be a function of the lag phase berry weight. Accordingly, it may be preferred that a grower perform a yield estimation during what is estimated as a lag phase, in order to estimate a final crop yield for that crop at harvest. This final crop yield estimate, in accordance with various embodiments, may be useful for, for instance, a vineyard attempting to determine if they will have a deficit or surplus of grapes come harvest time, to accordingly arrange for purchase or sale of grapes to meet a demand, contractual requirements, winery tank capacity, or the like.

However, despite the importance of accurately assessing and predicting a growth phenology over time (e.g. a lag phase in which an accurate yield estimate may be performed), doing so remains a challenge. For example, the plot of FIG. 1 provides an example of idealised grape behaviour sampled approximately once per week over most of growing season. To make accurate and informed crop management decisions, however, a grower must be able to observe trends in real time using limited crop data. This is challenged by many factors, including, for instance, an availability of data, which may be difficult to obtain and/or infrequently acquired; noisy data; and/or inconsistent trends in crop size and/or growth arising from a variable crop response to weather and/or irrigation applications. In many cases, a grower may only retrospectively learn when a lag phase has occurred, while it would be preferable to have known of a lag phase in advance. Various embodiments relate to a system and method operable to provide such advanced notice.

One approach to monitoring crop growth is the use of a dendrometer or similar instrument operable to assess a crop dimension (e.g. a berry width, firmness, rigidity, weight, or the like), or a proxy therefor (e.g. a berry width may be employed to estimate a berry weight). While such a sensor may be configured to acquire data consistently, extracting useful information therefrom is difficult. For example, U.S. Pat. No. 10,631,474 entitled “Method and System for Treating Crop According to Predicted Yield” and issued to Guy, et al. on Apr. 28, 2020 discloses a method of operating a crop treatment system in response to dendrometer readings from crops such as almond trees and cotton. However, as is common with such dendrometer readings, extracted data is limited to a daily growth value and a maximum daily shrinkage (MDS). In the disclosure of Guy, these values are coarsened by a “plant status function”, the output of which essentially indicates whether or not a crop should be irrigated. The decision is based on a loose correlation between previously observed crop yields and the output of the plant status function, which generally encourages a watering event when it is deemed that a crop is underwatered. Indeed, the art in general appears limited in its ability to accurately assess a crop phenology, such as a fine-grained determination of crop stage or progress therethrough. Yet more so does the art appear limited in its ability to provide a detailed or accurate estimation of future crop behaviour based on a crop size for the purposes of, for instance, timing a yield estimation, or timing an optimal harvest time to provide a grower with sufficient accuracy and/or advanced notice to efficiently take appropriate action.

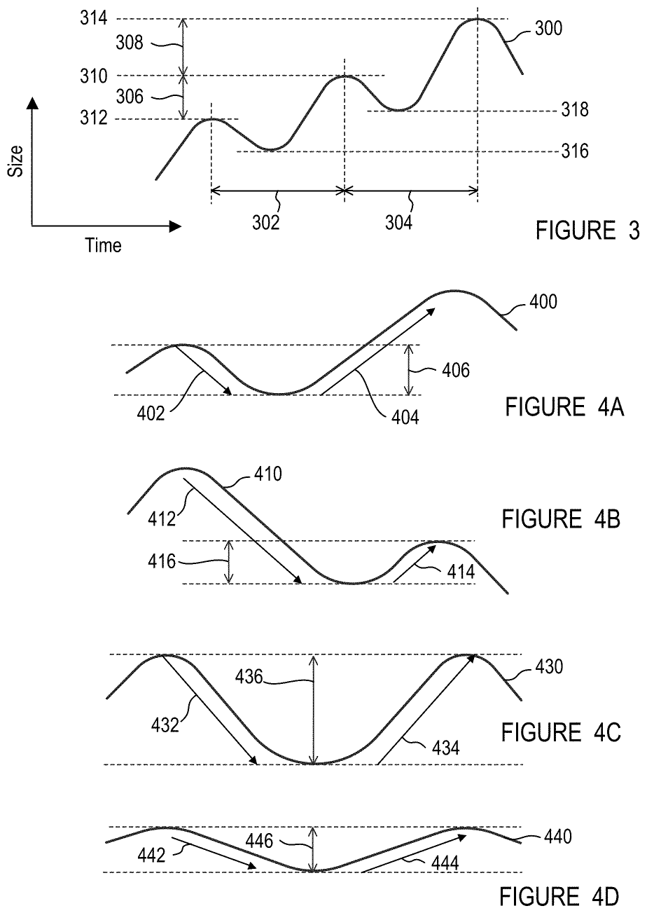

Among the challenges limiting the utility of dendrometer readings in existing systems are a high degree of variability in measurements, not only over the course of a growing season, but also over hours to days, and a lack of understanding of the sources of such “noise”. For instance, FIG. 2 shows an illustrative plot of an exemplary crop size 200 (e.g. dendrometer readings 200 of a grape) over a portion of a growing season.

It will be appreciated that the schematic of FIG. 2 is provided for illustrative purposes, and that general trends therein may be exaggerated for clarity. Indeed, while various aspects of the exemplary plot of FIG. 2 are known in the art, such as general growth trends during different crop phases, various other aspects are exaggerated to more clearly highlight observations related to crop stages that comprise various aspects of various embodiments herein disclosed.

As described above with respect to FIG. 1, the crop size 200 in FIG. 2 exhibits general growth trends 210 and 212 during Stages I and III, respectively, while Stage II exhibits a lag phase 214 wherein relatively little growth is observed over several days. However, a variability in the crop size over the course of a single day is generally observed during all phases. As will be appreciated by the skilled artisan, a crop may generally exhibit such a daily trend comprising a decrease in size during daylight hours via, for instance, evapotranspiration arising from sunlight, high temperature, or the like, and an increase in size during the night as a crop reabsorbs water from soil. For example, the daily cycle 216 comprises a daily maximum value in size 218 which decreases to a daily minimum in size 220. Such a trend is typically observed for a crop throughout a growing season, although it is appreciated that daily extrema 218 and 220, as well as size values recorded therebetween, may be affected by various factors, such as an amount of sunlight or irrigation received throughout the day. Similarly, it is known in the art that the daily maximum 30 may generally increase day to day (referred to herein as a “daily growth”) during growth phases 210 and 212, while a lag phase 214 may be characterised by a daily growth that approaches zero, is zero, or is relatively small.

Further appreciated by the skilled artisan is the notion that a maximum daily shrinkage (MDS) may be observed for a crop, which is a measure of the difference between a daily maximum 218 and daily minimum 220 in crop size. Also schematically shown in FIG. 2 is a crop shrivel stage 222, which, as alluded to above, is characterised by a decrease in crop size after a zenith 224 (e.g. a general maximum 224 of crop size), whereby, for some crops, and in accordance with some embodiments, a decrease in crop size may then be observed that is accompanied by other crop maturation stages (e.g. an increase in TSS content).

In practice, variability in real crop data presents challenges for extracting meaningful information therefrom. Accordingly, less appreciated in the art is the observation that daily variations in size (e.g. the difference in size between extrema 218 and 220) may, in accordance with various embodiments, be characteristic of a crop stage. For example, Stages I and II of FIG. 2 are characterised by larger daily variations than those observed in Stage III. This may arise from a number of effects, depending on, for instance, the type of crop. For instance, this behaviour may arise in grapes due a structural change in the crop whereby, in accordance with various embodiments herein described, the crop does not easily lose and recover water lost over the course of the day as readily in a later stage of growth (e.g. Stage III) as it once did. That is, while a young crop rapidly growing in Stage I is able to both lose and recover size after periods of mild or severe stress via water replacement through the xylem, more mature grapes in Stage III (e.g. after veraison) in part lose the xylem as a method of fluid conduit, thereby leading to less daily fluctuation in size.

Even equipped with this observation, there remains the challenge of extracting meaningful information from dendrometry data with respect to characterising a crop phenology. This challenge may further be exacerbated for automated digital systems using conventional parameters, such as MDS, which are agnostic to important phenological crop properties, such as the ability to recover water or general crop size over a time interval.

A need therefore exists for a means of assessing a crop phenology, for at least the reasons suggested above. Accordingly, the systems and methods herein described provide for, in accordance with different embodiments, different examples for assessing, monitoring, and/or providing an indication related to a crop phenology so to, for instance, better inform crop management practices. Furthermore, various embodiments relate to predicting, based on sensed crop parameters (e.g. crop size measurements), a temporal aspect of future crop phenologies or stages.

For example, the systems and methods herein disclosed may relate to the provision of an indication that a particular crop practice (e.g. a yield estimation, harvesting, cluster thinning, leaf removal, apply crop protection, or the like), is recommended for a designated time in the future. This may, for instance, provide a grower with adequate time to prepare for the crop practice.

In accordance with further embodiments, various systems and methods herein disclosed may further relate to suggesting to a grower a particular crop management practice (e.g. an irrigation or fertigation) to influence a progression of a crop phenology (e.g. to delay or initiate a progression in a growth stage).

Various embodiments may further relate to accurately assessing a crop phenology to inform crop management decisions with respect to a crop return on investment (ROI). For example, and without limitation, a crop phenology assessment may comprise a determination that a crop is in an early stage of phenological development, and therefore may not benefit from an irrigation from the perspective of the cost of the irrigation to a grower as compared to the benefit of the irrigation in terms of crop yield, quality, and/or value. Conversely, upon determining that a crop is, or is soon to be, in a lag phase, a system or method as herein described may recommend that irrigation be applied so to increase a ROI for the grower.

In accordance with yet other embodiments, a crop management practice suggested or determined by a system or method as herein described may further be automatically implemented as or by a component of the method or system.

To assess a crop phenology, in accordance with various embodiments, various systems and methods may employ a dendrometer or like sensor to acquire a measurement of a crop dimension, size, weight, pressure (e.g. turgor pressure), or the like. While different embodiments may relate to different configurations of a dendrometer, the following description is provided with respect to a dendrometer configured to assess a grape size (e.g. a grape width, length, weight, or the like). However, different embodiments may relate to a dendrometer configured to measure a property of, for instance, an almond, a hazelnut, a cherry, a crop stem width, a leaf or flower size, or the like. For example, and without limitation, a dendrometer configured to measure a nut size may, in accordance with various embodiments, be employed within a system or method as herein disclosed to assess a phenology of the nut or the crop associated therewith to assess or predict, for instance, a hull split. Similarly, a dendrometry measurement of a cotton plant may be provided via a dendrometer to assess various growth stages of a cotton crop.

It will be appreciated that such sensor may, in accordance with various embodiments, be in network communication with, for instance, a digital data processor or digital application operable to receive and/or process sensed data. In accordance with various embodiment, such a sensor may further be operable to periodically (e.g. every 10 seconds, every minute, every 10 minutes, every hour, or the like) or continuously acquire data. Such data may be acquired, in accordance with different embodiments, over time, and/or over a growth season. For instance, a sensor may acquire data between fruit set and harvest. Conversely, and in accordance with some embodiments, a sensor may acquire data over a period of several days of interest (e.g. based on an observed crop property, such as ripeness, colour, size, or the like). In accordance with yet other embodiments, a sensor may be operated over an arbitrary time interval as designated by, for instance, a grower or digital crop management system, and/or may be operably coupled with a crop (e.g. a stem or vine) as long as the crop is viable (e.g. between growing seasons).

In accordance with various embodiments, a system or method may employ a plurality of crop sensors. For example, a crop field may have operable therein any number of sensors associated with different crops or crop location regions, each acquiring independent measurements. Such measurements may, in accordance with various embodiments, be processed independently to assess crop phenologies associated with different crops or crop types. For instance, and without limitation, a crop phenology assessment process or system may determine that a crop in a first row (e.g. Row “A”) is currently exhibiting signs of an imminent lag phase, while a second row (e.g. Row “B”) is nearer to halfway through an earlier crop phenology phase (e.g. Phase I). Accordingly, and in accordance with various embodiments, a crop phenology assessment system or method may provide an indication or alert that Row A may be assessed as comprising a preferred row in which a yield estimation should be performed within a designated amount of time (e.g. within 3 days), while an indication (or lack of indication) may be provided from a system or method that Row B need not yet be assessed for a yield estimation.

Additionally, or alternatively, different crop regions may comprise different crops (e.g. different grape varietals), which may be preferentially harvested at different crop phenology stages (e.g. in accordance with different TSS values). Various embodiments therefore relate to a system or method (or a plurality thereof) operable to independently process measurements from different crop regions in order to provide an alert or recommendation with respect to a harvest time on a crop location-specific basis.

In accordance with yet other embodiments, a crop phenology assessment system or method may evaluate such criteria to provide a crop treatment scheme (e.g. a harvest schedule, a yield estimate schedule, irrigation applications, or the like, across multiple crop locations) on a crop location-specific basis. For instance, various embodiments relate to the use of crop phenology estimates, generated in accordance with the systems and methods herein described, for a plurality of crop locations, thereby suggesting, and/or automatically implementing, crop management practices for multiple respective crop locations concurrently or at different designated times (e.g. via automated irrigation systems).

In accordance with various embodiments, the systems and methods herein disclosed provide for an assessment of a phenological crop characteristic based at least in part on the calculation of various parameters related to data acquired as a crop size measurement (e.g. a dendrometry measurement). For example, a crop characteristic, such as crop growth stage, a progression therethrough, a crop maturity, a crop ripeness, a brix content, a yield prediction, a crop grade, or the like, may assessed based on the monitoring of various parameters related to crop phenology.

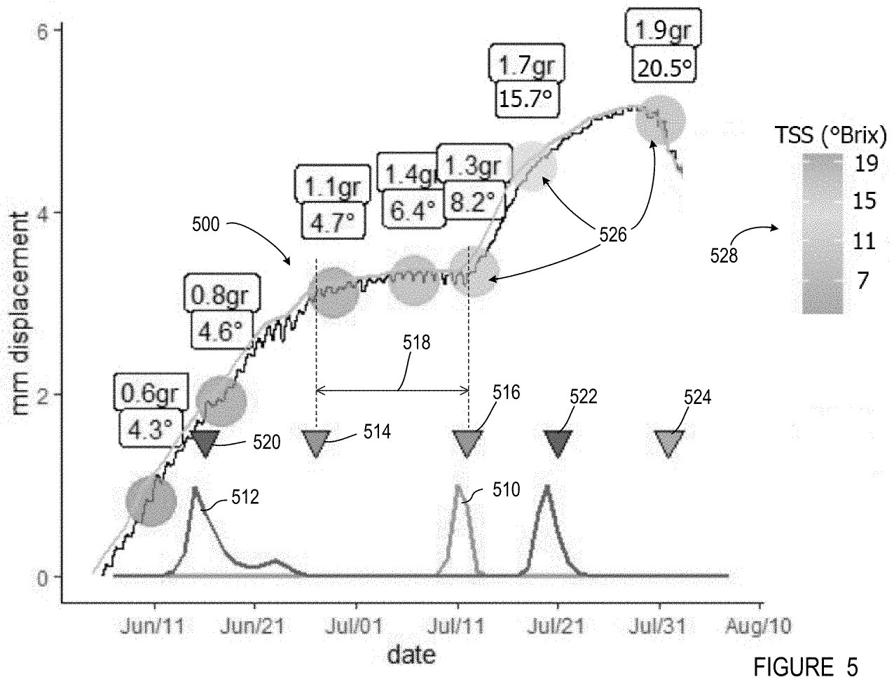

To further appreciate various aspects of the embodiments herein described, FIG. 3 shows an exemplary plot of a sensed crop size 300 (e.g. a grape size 300 determined from dendrometer readings) as a function of time over the course of approximately two days 302 and 304. In this example, a crop size 300 is generally observed to increase over two days, as will be further described below. However, it will be appreciated that the description provided with respect to FIG. 3 may be applied to a crop phenology or growth stage regardless of whether a crop is generally increasing in size, as shown in FIG. 3, shrinking, or remaining relatively consistent, day to day.

In the example of FIG. 3, a crop size 300 is generally increasing over the course of two daily cycles 302 and 304. This may be understood as daily increases 306 and 308 in daily maximum size (i.e. daily growth 306 and 308) corresponding to the differences in maxima 310 and 312, and 314 and 310, respectively, over daily growth cycles 302 and 304. Restated, a daily growth (e.g. daily growth 306) corresponds to a difference in maxima (e.g. 310 and 312) of the crop size profile 300 during a crop growth day 302. Similarly, the daily growth 308 corresponds to the change in size between the maxima of crop size measurements 314 and 310 during the daily cycle 304.

While the beginning and end points of daily growth cycles 302 and 304 correspond to maxima 310, 312, and 314 in FIG. 3, it will be appreciated that various time points may be employed in the calculation of a daily growth cycle (e.g. size measurements 300 acquired for non-extremum values), without departing from the general scope, spirit, or nature of the disclosure. For instance, a daily size profile may comprise temporal definitions of a start and end point of a daily cycle that correspond to a time of day that does not correspond to an extremum in a daily crop size, in accordance with different embodiments. Accordingly, the dashed vertical lines denoting the daily cycles 302 and 304 may, for instance, be shifted with respect to the growth curve 300, without departing from the general scope or nature of the disclosure.

In the example of FIG. 3, daily minima 316 and 318 are further observed during the daily cycles 302 and 304, respectively. As will be appreciated by the skilled artisan, a MDS calculation may comprise the difference between a daily maximum (e.g. the daily maximum 312) and daily minimum (e.g. the daily minimum 316) in a crop size. Similarly, the difference in the maximum 310 and minimum 318 during the daily cycle 304 may comprise a MDS value for the crop during the daily cycle 304.

In accordance with various embodiments, a first parameter that may be calculated for the assessment of a crop phenology may comprise a daily crop recovery value. In contrast with parameters known in the art for characterising a crop status, such as MDS, a crop recovery value, in accordance with various embodiments, may inherently comprise, or accentuate, phenological crop stage characteristics, or a stage of progression therethrough.

A crop recovery value may be generally understood, in accordance with various embodiments, as the as an amount of crop size recovered from what was lost during a daily cycle or other periodic crop cycle. That is, in accordance with a daily cycle, a crop recovery value may comprise an increase in crop size observed during a daily cycle that contributes to a recovery of crop size that was lost earlier during that daily cycle. On the other hand, a crop recovery value may be limited in part based on a previous daily maximum. That is, should a crop size increase in size past a previous daily maximum, the crop may only “recover” the value in size that returns it to the previous maximum (i.e. it may only recover the amount of size that was “lost” since the maximum), even if it also gained further size in addition thereto.

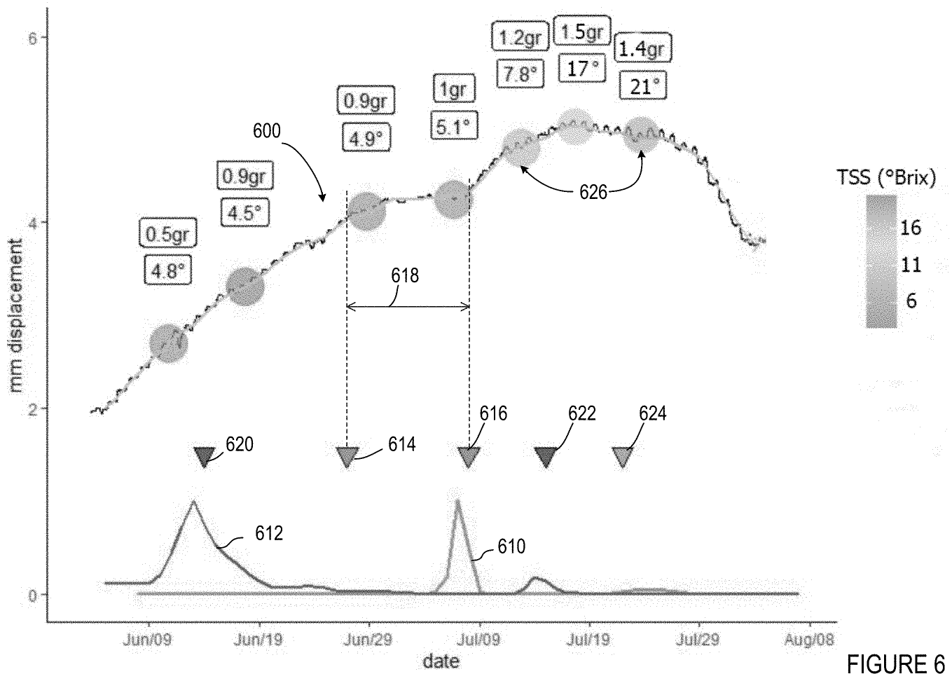

To further clarify the notion of a daily crop recovery value, FIGS. 4A to 4D schematically illustrate respective daily crop recovery values corresponding to daily cycles of a daily crop growth (increasing daily maxima, FIG. 4A), a daily crop shrinkage (decreasing daily maxima, FIG. 4B), and daily cycles in which no crop growth was observed (no increase or decrease in daily maxima, FIGS. 4C and 4D).

In the example of FIG. 4A, a crop exhibited size 400 characterised by a daily growth, schematically shown as an increase in daily maxima of the crop size 400. In this example, the crop size 400 decreased 402 from a daily maximum to a daily minimum, followed by an increase 404 in size on route to a subsequent daily maximum. The daily crop recovery value 406 in this exemplary case is denoted as the amount of crop size gained after the daily minimum until it recovered all of the size that was lost that day. Accordingly, while the size 400 generally grew in accordance with a daily growth corresponding to the difference between adjacent daily maxima, and grew by an even greater extent in view of the growth 404 from the daily minimum to the subsequent daily maximum, the crop recovery value 406 corresponds to the amount of crop size that was recovered from what was lost (e.g. size recovered of that was lost since the previous daily maximum).

On the other hand, FIG. 4B schematically shows a similar crop size profile 410 acquired during a daily cycle in which a crop generally decreased in size (i.e. exhibited a negative daily growth value), as illustrated by a decrease in the crop size between daily maxima. In this example, the crop size 410 decreased 412 in size to a daily minimum before again increasing 414 in size, but to a lesser value than was observed for the previous daily cycle. The daily crop recovery value 416 again corresponds to the amount of size that was recovered 414 from what was lost 412 that day. However, unlike the example of FIG. 4A, the crop of the exemplary plot of FIG. 4B did not recover all of the crop size that was lost over the course of the day.

FIG. 4C shows another example of a daily growth profile 430. In this example, the crop did not exhibit a daily growth, as adjacent daily maxima comprise the same value of crop size. However, the crop size profile 430 again exhibits both a decrease in size 432 and a subsequent increase in size 434. In this case, the daily crop recovery value 436 corresponds to the entirety of the growth 434, as all of the size increase 434 corresponds to a recovery of crop size lost during the crop size decrease 432.

Like FIG. 4C, FIG. 4D shows an exemplary crop size profile 440 during a daily cycle in which no daily growth was observed. However, in this example, the amount of variation in crop size 440 observed throughout the day was less than that of the example of FIG. 4C. That is, while the crop size decreased 442 before increasing 444 to the previous day's maximum value, these changes in crop size over the course of the day were less significant than those of FIG. 4C. Accordingly, while the crop recovery value 446 again comprises the entirety of the crop size increase 444, its value is less than that of the daily crop recovery value 436 of FIG. 4C, as a greater amount of absolute size was recovered in FIG. 4C.

While the exemplary plots of FIGS. 4A to 4D show crop size profiles comprising single peaks corresponding to daily maxima, it will be appreciated that in some circumstances, a daily crop size profile may exhibit more than one local maximum or minimum throughout a day. In such situations, a crop may shrink over two or more time periods, resulting in recovery periods that may be observed more than once per day. In accordance with some embodiments, each recovery period arising from such fluctuations may contribute to a daily recovery value. This may therefore result in a greater daily recovery value than would otherwise be observed for a crop beginning and ending a daily cycle with comparable sizes, but only exhibiting a single peak in daily crop size. Similarly, noise in a crop size measurement may contribute to many perceived recovery periods, which may, in some embodiments, contribute to a recovery value. It will be appreciated that various signal processing and/or filtering processes may be applied to crop size profiles, which may then affect a daily recovery value. However, various embodiments may alternatively relate crop size profile processing in which such short-term crop size fluctuations do no contribute to a recovery value.

Furthermore, and in accordance with some embodiment, a crop recovery value may comprise a periodic value. For example, while the description provided above relates to a daily crop recovery value (e.g. the amount of crop size recovered over the course of a day), other embodiments relate to monitoring crop recovery values over other time intervals. For example, crop recovery values may be monitored over periodic intervals of, for instance, 12-hour periods, every two days, every week, or the like. It may also refer to crop recovery values relating to non-repeating, irregularly, or semi-regularly occurring events; for example, recovery values after repeated or non-repeated precipitation or irrigation events, droughts, harvesting events, fire- or smoke-related events, freezing and/or thawing events, crop application events, crop treatment events, or combinations thereof. Accordingly, while the embodiments herein described may relate to daily crop recovery values, it will be appreciated that various other periodic intervals or intervals after non-repeating or irregularly repeating events may be assessed to determine periodic values.

Returning again to the exemplary crop size profile 200 of FIG. 2, one can therefore observe that daily crop recovery values acquired for the crop in Stages I and II, where there is a greater daily variability in crop size and a generally high degree of crop size that is recovered on a day-to-day basis, would generally be greater than those measured for the crop in Stage III.

Further, it will be appreciated that a crop recovery value may be indirectly related to crop growth rate. For example, while a crop is rapidly growing (i.e. exhibiting large changes in daily maximum values of crop size), a crop may only decrease in size by a small extent over the course of a day as compared to a crop that generally exhibits the same relative amount of daily fluctuation, but returns to the same size value observed when the day began (i.e. a crop that is not exhibiting a daily growth). Accordingly, a rapidly growing crop that is only losing a small amount of size over a day is similarly limited in the amount of size that can be recovered. Similarly, a generally shrinking crop (e.g. one in late Stage III) may only regain a small fraction of size lost over the course of a day, and may therefore similarly be limited in daily crop recovery values.

A daily crop recovery value, in accordance with various embodiments, may therefore be useful in assessing a crop phenology or crop stage. For example, Table 1 is a data table comprising exemplary data related to a crop size over a portion of a growing season. It will be appreciated that the data in Table 1 is provided for illustrative purposes, and do not necessarily reflect actual data acquired from a crop.

TABLE 1
Exemplary Crop Data and Associated Parameters.

| Daily | DR Window | | Daily Growth | Inverse Daily | IDG Window | | DG Window |
|---|---|---|---|---|---|---|---|
| Recovery | Product | Daily | (DG) Value | Growth | Product | DR WP × | Product |
| (DR) Value | (n = 3) | Maximum | (Abs. Value) | (IDG) Value | (n = 3) | IDG WP | (n = 3) |
| 2 | | 5 | | | | | |
| 1 | | 6 | 1 | 1.00 | | | |
| 2 | 4 | 10 | 4 | 0.25 | | | |
| 2 | 4 | 15 | 5 | 0.20 | 0.05 | 0.20 | 20.00 |
| 1 | 4 | 19 | 4 | 0.25 | 0.01 | 0.05 | 80.00 |
| 2 | 4 | 22 | 3 | 0.33 | 0.02 | 0.07 | 60.00 |
| 4 | 8 | 23 | 1 | 1.00 | 0.08 | 0.67 | 12.00 |
| 7 | 56 | 22 | 1 | 1.00 | 0.33 | 18.67 | 3.00 |
| 8 | 224 | 23 | 1 | 1.00 | 1.00 | 224.00 | 1.00 |
| 7 | 392 | 22 | 1 | 1.00 | 1.00 | 392.00 | 1.00 |
| 2 | 112 | 25 | 3 | 0.33 | 0.33 | 37.33 | 3.00 |
| 1 | 14 | 30 | 5 | 0.20 | 0.07 | 0.93 | 15.00 |
| 2 | 4 | 34 | 4 | 0.25 | 0.02 | 0.07 | 60.00 |
| 1 | 2 | 36 | 2 | 0.50 | 0.03 | 0.05 | 40.00 |

Data such as that exemplarily shown in Table 1 may be obtained, in accordance with various embodiments, by processing crop size data as described above. For example, the leftmost column of Table 1 comprises daily recovery (DR) values. Crop size data may also be processed to determine daily maxima, which may in turn be used to extract daily growth values (DG). It will be appreciated that various measurements or calculation processes may determine positive or negative values, or may comprise absolute values. For example, the DG values in Table 1 are reported as the absolute value of the difference in daily maxima of crop size.

In accordance with various embodiments, such data may be further processed to, for instance, accentuate small differences between daily values. For example, and in accordance with various embodiments, the second left-most column of Table 1 shows the product of a designated number of DR values, also herein referred to as a “window product”. In this case, each DR value is multiplied with the previous two DR values (for a total window size n=3) to calculate a window product value. For example, the first DR window product value is calculated as 2×1×2=4, while the second DR window product value is calculated as 1×2×2=4. Notably, and in accordance with various embodiments, window product values may differ significantly for even relatively small changes in a measured values (e.g. DR values).

It will be appreciated that this description of a window product is provided for illustrative purposes, only, and that different embodiments relate to the use of different calculation processes known in the art of, for instance, signal processing. However, for illustrative purposes, Table 1 further shows window products values associated with daily growth (DG) values, as well as inverse daily growth (IDG) values, in accordance with some embodiments. As with DR window product values, window product values corresponding the DG values, and IDG values comprising the inverse of DG values (i.e. 1/DG), accentuate even small differences in corresponding metrics between days, in accordance with various embodiments.

With respect to characterising a crop phenology or growth stage, various parameters, non-limiting examples of which are included in Table 1, may be characterised, in accordance with various embodiments. For example, a first parameter that may be useful in assessing a crop phenology is the product of daily recovery window product (DR WP) and the inverse daily growth window product (IDG WP), since, as described above, various crop stages may be characterised by respective growth trends, as well as daily variability and/or recovery of crop size. For example, Stage I of crop growth may be generally characterised as comprising relatively high variability, and therefore corresponding daily recovery values, as compared to a Stage III crop. Similarly, a Stage I crop may also be characterised by relatively high daily growth values as compared to a Stage II or lag phase crop.

Accordingly, a first parameter comprising the product of daily recovery values and inverse daily growth values may comprise relatively small values during Stage I of crop growth. Indeed, as seen in the DR WP×IDG WP column of Table 1, the effects of daily recovery are effectively diminished by very small factors of IDG when a crop is growing rapidly. Stated differently, by employing the inverse of a large daily growth in a first parameter calculation, the resultant product with daily recovery values remains relatively small.

Conversely, as a crop approaches Stage II, or lag phase, a crop may generally be characterised as having relatively large daily recovery values, while daily growth rates decrease. Accordingly, the inverse of daily growth values, or a window product thereof, may become larger, as illustratively shown by the rapidly escalating values of DR WP×IDG WP for data points corresponding to diminished daily growth. While various mechanisms may result in increasing such a parameter, it will be appreciated that various embodiments relate to a first parameter that effectively monitors daily growth values in order to detect and/or generate an alert with respect to escalating or extreme values of the first parameter.

In accordance with some embodiments, calculation of such a first parameter may provide a strong indication as to a flattening of a crop size profile near the end of a Phase I crop stage. Accordingly, monitoring such a first parameter may be useful in providing an early indication of an impending lag phase. For example, various embodiments relate to monitoring such a first parameter and providing an indication to a grower upon the first parameter exceeding a threshold value, or upon the detection of a rapid change of the first parameter. Given the importance of properly predicting a crop lag phase to, for instance, perform a yield estimate, such embodiments may be tremendously useful for, for instance, a vineyard, wherein a properly timed yield estimate may greatly improve resource management and a crop purchase or sale to meet a wine demand at the end of a growing season.

Further, and as will be discussed below, a first parameter comprising a daily recovery value and an inverse daily growth value, and/or corresponding window products thereof, may provide an indication of the end of a lag phase, in accordance with various embodiments. Accordingly, monitoring such a first parameter may provide a means of accurately assessing various stages of crop growth so to more effectively monitor a crop phenology.

In accordance with some embodiments, a second parameter may further be monitored to automatically detect other aspects of crop phenology. For example, and in accordance with various embodiments, a second parameter comprising daily growth values may be monitored to detect, for instance, characteristic features of Stages I and III described above.

For example, the rightmost column of Table 1 shows exemplary data illustrating a second parameter comprising daily growth window product values. Naturally, this second parameter, which uses DG values in a calculation process rather than the inverse values thereof, provides a larger second parameter value as daily growth values increase. Interestingly, the window product of the daily growth values provides an excellent measure of the midpoint of sigmoidal growth profiles, as is often observed in Stages I and III of crop phenology.

While the daily recovery values in Table 1 are processed as described above with respect to FIGS. 4A to 4D, it will be appreciated that various embodiments may additionally or alternatively relate to daily recovery values and/or first parameters that are determined in accordance with an alternative calculation process. For example, various embodiments relate to the calculation of a first parameter that is based at least in part on a maximum daily shrinkage (MDS) value. For example, and without limitation, a first parameter may be a function of an MDS value divided by a daily maximum in crop size, or absolute value thereof. Alternatively, or additionally, a first parameter may comprise a term related to a MDS divided by a daily growth rate, or the absolute value thereof. The first parameter may further comprise a window product of such a term, as described above. In accordance with yet further embodiments, and as described below, a first parameter may relate to alternative terms that may reflect or otherwise comprise one or more historical crop size measurements and/or functions thereof. Accordingly, in some embodiments, a first parameter may represent or be reflective of trends in crop size and/or a behaviour over longer time scales than, for instance, that reflected by an MDS value, which, in conventional practices, may be limited in temporal scope and ‘memory’, and may therefore not adequately and/or accurately represent a crop status or parameter.

Furthermore, it will be appreciated that various recovery parameters may be measured, calculated, or inferred based on sensed crop data, in accordance with various embodiments. For example, as a crop recovery is, in some embodiments, related to water uptake by the crop, a crop recovery value (and indeed second parameter calculations) may be influenced by irrigation practices or weather (e.g. rainfall, humidity, temperature, wind, or the like). Accordingly, various embodiments relate to the employ one or more normalisation criteria to determine a crop recovery value. For example, and without limitation, a first parameter for monitoring a crop phenology may be based, at least in part, on a soil moisture value, which may be used to normalise or otherwise account for high (or low) amounts of water available to a crop, or for other environmental or sensed conditions. In accordance with some embodiments, data acquired by a plant water status sensor, a weather sensor, or the like may similarly be used in the calculation of a recovery value, or a first or a second parameter. Such normalisation in accordance with an environmental parameter may improve data accuracy, reproducibility, or usability by, for instance, reducing noise in measured or calculated signals.

For example, high vapour pressure deficit (VPD) may result in a greater rate of crop water loss, which may ultimately lead a greater daily or periodic recovery values. Conversely, if a VPD is low during a time that a grower is, for instance, heavily irrigating a crop, or prior to a large rainfall, recovery values may be generally lower than they would otherwise be during, for instance, a phenological crop stage typically characterised by high recovery values.

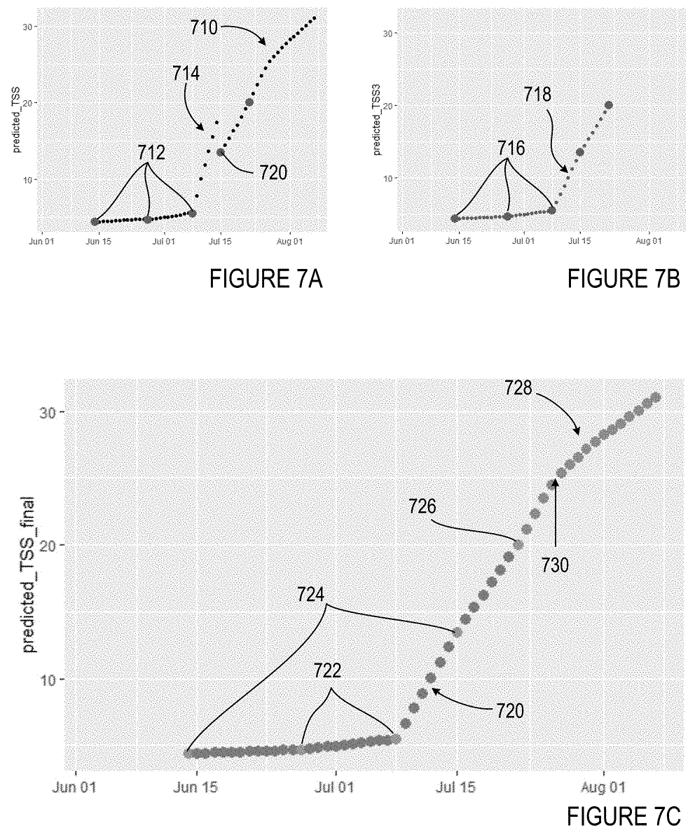

In accordance with various embodiments, FIGS. 5 and 6 show exemplary plots of two different crop size profiles acquired over the course of approximately two months of a growing season. In these examples, crop size measurements are illustratively presented as dendrometer displacement measurements as a function of time. It will be appreciated that while the plots of FIGS. 5 and 6 show a relatively large fraction of a growing season, various embodiments may additionally or alternatively relate to monitoring crop size over a shorter time period (e.g. Stages I and II, several days, several weeks, one phenological stage, or the like). Conversely, various embodiments may relate to monitoring a crop dimension over longer periods (e.g. several years). For instance, such embodiments may relate to monitoring a crop dimension during a dormant phase of a crop.

In FIG. 5, the crop size profile 500 generally follows the crop phenology described above with respect to Stages I to III. In this example, however, curves 510 and 512 plotting first and second parameters monitored over the growing season are also shown. In this example, curves 510 and 512 are normalised to fit on the y-axis scale of the plot of crop size 500. In this embodiment, the first parameter 510 plotted is the result of a calculation process comprising the multiplication of the 3-day window product of daily crop recovery values and the 3-day window product of the inverse of daily growth values, as described above. During monitoring of this first parameter, threshold values of the first parameter 510 were set to trigger a corresponding indication related to the threshold being exceeded. While a large peak is observed in the plot 510 of the first parameter corresponding to the second trigger 516, a first trigger corresponding to the triangle 514 also relates to a peak in the plot 510 exceeding a first parameter threshold that is not visible on this scale.

Interestingly, the time span 518 between trigger events (e.g. threshold crossings) in monitoring of the first parameter 510 corresponds to a lag phase 518 of the crop. Accordingly, upon detection of the first threshold crossing 514, a user may be provided an indication that the threshold crossing has been observed. For example, an indication may comprise a notification or alert provided via a digital application on, for instance, a smartphone, with respect to the initiation of lag phase. The user may then accordingly be given several days' notice to prepare for, for instance, a yield estimate. Such an alert or indication may further be useful in determining the onset of veraison, or crop ripening. For example, while some crops, such as red grapes, may naturally provide an indication of ripening via a colour change at, for instance, the end of Stage II and/or beginning of Stage III, ripening of other crops, such as white grapes, may go unnoticed if a lag phase or veraison is missed. Accordingly, various embodiments relate to providing such indications to a user to further improve any crop practices impacted by an accurate phenological timing thereof. Non-limiting examples of a user that may be provided with an indication related to crop phenology may include, but are not limited to, a grower, an irrigation manager, a crop manager, a water management company, or the like.

It will be appreciated that the first parameter 510 monitored during crop growth may correspond to either end of a plateau in a crop size profile. Alternatively, or additionally, a rapid rise in the first parameter may relate to an indication of the end of a sigmoidal growth period, or the initiation of, for instance, a second growth stage following a lag phase. Accordingly, a first parameter monitored as described with respect to FIG. 5 may comprise additional peaks, such as when the sigmoidal growth stage of Phase III is nearing an end. While knowledge of such a phenological crop stage may be useful for some applications, and is accordingly considered within the scope of some embodiments, various other applications may opt to provide only two triggers corresponding to the first parameter, such as the triggers 514 and 516 in FIG. 5 denoting the beginning and end of lag phase 518.

Alternatively, or additionally, it will be appreciated that various embodiments comprise a plurality of threshold values from which to generate a notification to a grower or user. For example, the threshold corresponding to the trigger/notification 514 indicating the initiation of lag phase 518 was set to a lower value than that corresponding to the trigger 516. Such thresholds may be set based on, for instance, knowledge of the phenology of a particular crop. For example, it may be understood for a certain varietal of grape that respective first and second thresholds comprise respective values that are similar, while respective thresholds for a second grape varietal may differ by orders of magnitude based on, for instance, historically observed data trends for that particular crop.

Similar to the first parameter 510, the plot of the second parameter 512 also provides two distinct indications 520 and 522 corresponding to respective threshold detection events. In this example, the second parameter 512 comprised the window product of three consecutive daily growth values. Peaks in the second parameter plot 512 corresponding to trigger events 520 and 522 indicated, in FIG. 5 and in accordance with various associated embodiments, midpoints of respective sigmoidal growth profiles in Stages I and III, respectively. As will be appreciated by an examination of the growth curve 500, these phenological crop events would not be easily detected in real time due to noise and variation in the acquired crop size signal 500. However, monitoring of the second parameter based at least in part on daily growth values of the crop generated indications 520 and 522 (e.g. alerts or notifications) that each growth phase had reached an approximate midpoint, allowing a grower to adequately prepare for upcoming crop management practices.

As with monitoring of the first parameter 510, monitoring the second parameter 512 may comprise different threshold values and/or process logic. For example, while there appears to be a shoulder to the peak corresponding to the alert 520 generated in response to the second parameter exceeding a threshold, a process or system may not provide an alert to such a high second parameter value due to a logic step that requires, for instance, that the second parameter return below a designated value before providing a second trigger alert, or that the crop phenology assessment system or method recognise a peak 514 and/or 516 corresponding to a lag phase before assessing a growth profile 500 for subsequent trigger events associated with the second parameter 512.

Triggered notifications 520 and/or 522 with respect to the second parameter 512 may be useful to assess various phenological crop stages. For example, a notification 522 may alert a grower that the approximate midpoint of an expected sigmoidal growth during Stage III has been observed; in other embodiments, such trigger notifications may be used to alert a grower of the existence of or changes in other phenological statuses (e.g., a status when watering or other application will promote increased yield, will have little or significant impact on a particular crop status, crop stress, harvesting timing for achieving a particular crop outcome, etc.). This may, for instance, inform the grower that a crop may reach a maximum size in a future amount of time corresponding to the amount of time elapsed since the end of lag phase, which was respectively indicated by an alert associated with the first parameter trigger 516. Accordingly, the grower may then prepare for a harvest time coinciding with the predicted maximum crop size 524, should they which to harvest at that particular phenological crop stage.

In accordance with some embodiments, a separate indications 524 related to a maximum crop size may similarly be provided by a subprocess of a method or system as herein described monitoring a third growth parameter associated with the crop size profile 500. For example, various peak fitting processes known in the art may be employed to analyse crop size data 500 to assess, in real time and in an automated fashion that is reproducible year-to-year (i.e. consistent from the perspective of crop phenology), when a crop has recently reached a maximum size, and thereby trigger an alert 524. It will be appreciated that the detection of a maximum crop dimension may comprise various process logic steps or criteria. For example, one embodiment relates to the assessment of a crop dimension for a seasonal maximum only upon observation of trigger events 516 and 522.

FIG. 5 further schematically illustrates TSS measurements 526 acquired at different time points throughout the crop growth cycle 500. In accordance with some embodiments, such values, reflected in the shading scale bar 528, may be used to further assess crop phenology, or may be used in conjunction with assessed phenological states and/or crop maturity to predict future TSS values through modeling to, for instance, select an appropriate time for harvest, as will be further described below.

FIG. 6 shows another example of a crop size profile 600 acquired throughout a portion of a growing season. As described with respect to FIG. 5, FIG. 6 also shows plots of a monitored first parameter 610 and second parameter 612, again comprising, respectively, values related to a daily crop recovery and a daily growth. Again, FIG. 6 schematically shows notifications 614 and 616 corresponding to, respectively, the beginning and end of lag phase 618, generated in response to the first parameter 610 exceeding designated threshold values. Similarly, notifications 620 and 622 were generated in response to monitoring of the second parameter 612 that indicated break points (e.g. approximate midpoints) of sigmoidal growth profiles in, respectively, Stages I and III. This example again schematically depicts a notification 624 generated in response to the observation of a recent peak in a third parameter, in this case the crop size 600, and measured TSS values 626 at various time points throughout crop size monitoring 600.

Additionally, or alternatively, indicators, notifications, and/or triggered responses (e.g. notifications 514, 516, 520, and 522) arising from monitoring of the first and second parameters, and/or optionally an indicator (e.g. notification 524) associated with a third parameter related to a maximum in crop size, may correspond to distinct, consistent, and/or reproducible time points in a phenological crop cycle at which various crop management practices may be performed. For instance, a TSS content profile for future times (e.g. harvest times) of a crop may be more accurately predicted when TSS content is evaluated at specific stages of a crop phenology (e.g. at the beginning and end of lag phases, at the midpoint 522 of the Stage III growth, or the like), rather than at regular time intervals (e.g. weekly). Accordingly, and in accordance with various embodiments, a grower may utilise a crop phenology assessment system or method has herein described to more consistently assess, for instance, a TSS content, or another crop property, thereby improving crop management and/or harvesting practices.

This aspect of crop phenology assessment may be of particular importance selecting an appropriate harvest time. For example, and as described above, a vineyard may prefer that certain grape varietals be harvest in accordance with very specific TSS values, which may be difficult to predict. This may lead to inefficient management of harvesting resources and/or personnel. However, an accurate assessment of a crop phenology, in accordance with various embodiments, may lead to more accurate predictions of future ripeness properties (e.g. TSS values) at specific times in the future, thereby improving harvest preparation. Further, this can be particularly useful for assessing crop ripeness or maturity on a crop location-specific basis, whereby a grower can efficiently employ resources to harvest in accordance with a harvest scheme generated to selectively harvest different crop locations in a particular order based on accurately predicted crop ripeness properties.

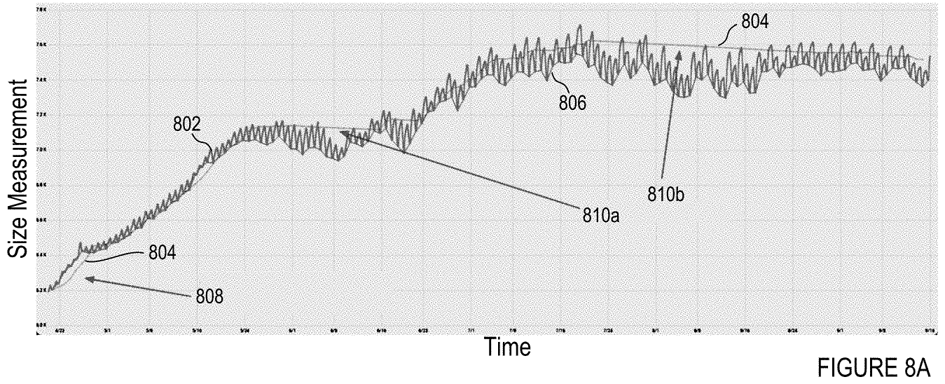

An exemplary embodiment related to assessment of crop phenology for the accurate prediction of a future crop property, such as a future crop ripeness parameter, is shown in FIGS. 7A to 7C. In this example, a total soluble solids (TSS) content in a grape is modeled as a function of time in accordance with a phenological model.

FIG. 7A shows an exemplary plot of the modeled TSS content 710 in a grape. In this exemplary embodiment, small data points indicate modeled TSS content between known or presumed TSS content values at distinct phenological maturation points indicated by large data points (e.g. large data points 712 and 720). For example, and in accordance with various embodiments, the large data points in FIGS. 7A to 7C may relate to phenological maturation points corresponding to trigger values 520, 514, 516, 522, and 524 associated with the first and second parameter monitoring shown in FIG. 5. As these phenological time points may be consistently and/or reproducibly detected between crops, crop locations, and/or growing seasons in accordance with the various embodiments herein disclosed, TSS values at such time points may by reliably inferred based on, for instance, previous values acquired for a particular crop and/or crop location at these specific known phenological maturation points. Accordingly, such values may be considered a ground truth or as reference values, which, in accordance with various embodiments, may remove the need to perform physical measurements of, for instance, TSS values throughout the growing season. In accordance with one exemplary embodiment, a model for a particular grape variety may assume, for instance, TSS levels corresponding to 4.4, 4.7, 5.5, 13.5 and 20.5 percent TSS for crop maturity points corresponding to the triggers 520, 514, 516, 522, and 524 of FIG. 5.

Conversely, if such reference values 712 were obtained from measurements performed at periodic, or otherwise arbitrary points with respect to crop phenology (i.e. not in accordance with well-defined phenological crop growth stages), a model may perform poorly at predicting future TSS values. This is illustratively represented as modeled behaviour 714 in which the predictive TSS model comprised parameters that were erroneously determined (e.g. such as if a TSS value was determined or measured at an unknown crop maturity level), resulting in inaccurate predictions 714 of TSS content leading up to the large data point 720. While in this case, phenological model parameters were erroneously selected for illustrative purposes, similar poor predictive results may be achieved predictive models if TSS data is input in association with phenological crop stage that is inaccurate.

Conversely, FIG. 7B shows TSS data 718 interpolated between data points 716 corresponding to specific phenological crop stages determined by a crop phenology assessment system, in accordance with various embodiments. For instance, such values may be acquired in response to indications provided in response to specific phenological events, as described above. As crop phenology is well-characterised at, for instance, time points 716, a phenological model may receive or access data TSS values 716 corresponding to specific stages of crop phenology, thereby allowing the model to better predict future values. For instance, in the example of FIG. 7A, the phenological model may predict erroneous values 714 between physical measurements of TSS that correspond to arbitrary phenological time points. While the model may be reparameterised upon receipt of new values (e.g. new measured value 720), without an accurate knowledge of crop phenology at time point 720, future values may continue to be poorly predictive. However, by receiving TSS values 716 in association with specific crop phenology stages, a phenological model will better predict future TSS values, in accordance with various embodiments.

A potential utility of this approach is shown in the plot of TSS values as a function of time in FIG. 7C. In this example, TSS values are again acquired at well-characterised phenological crop stages 722, 724, and 726 in response to notifications provided via a crop phenology assessment system or method, in accordance with various embodiments. For instance, TSS values 722 may be assumed upon receipt of the notifications 514 and 516 of FIG. 5 corresponding to the beginning and ending of lag phase 518, respectively, wherein these maturity points may be determined at least in part based on the monitoring of a first parameter related to crop recovery values. Similarly, TSS values 724 may be determined in response to notifications 520 and 522 generated in response to monitoring a second parameter calculated based at least in part on daily crop growth values, while the TSS value 726 may be assumed at the time point at which a maximum crop size 524 is predicted, or determined based on a notification 524 from a crop phenology assessment system monitoring a third parameter related to a maximum crop size.

FIG. 7C shows exemplary predicted TSS values 728 modeled based at least in part on phenologically relevant TSS values 722, 724, and 726, and or interpolated TSS values 720 therebetween. In accordance with various embodiments, a grower may prefer to harvest at a specific TSS value, shown in this exemplary embodiment as a TSS value 730 of 25. Based on predicted values 728, the grower may receive a notification related to a predicted time at which the crop will comprise a TSS value of 25, and may therefore plan to harvest accordingly.

Conversely, a champagne grape grower may prefer to harvest immediately or soon after the second trigger related to the second parameter (e.g. July 15 in FIG. 7C), while a different grower may prefer to harvest at the phenological maturity level 726 corresponding to the maximum berry size.

While the embodiment of FIG. 7C relates to an advanced notice of approximately 5 days with respect to a target TSS value (i.e. a notification provided at the time point 726 for a TSS value of 25), it will be appreciated that various embodiments relate to the provision of a notification with, for instance, one to two weeks of advanced notice. For example, a phenological model may continuously attempt to predict future crop ripeness parameters based on input data related to phenologically relevant crop stages. For example, a phenological model, in accordance with some embodiments, may forecast TSS values at every time point shown in FIG. 7C and provide a grower with a notification based thereon, while updating forecasted values as any new data is received or automatically recorded.

It will be appreciated that various embodiments may further relate to various different phenological models for inferring and/or predicting future crop maturity parameters (e.g. TSS content). For instance, the daily change in TSS level may be different for each of the intervals between the trigger points corresponding to phenological crop stages. Further, in some embodiments, a phenological model may employ degree days as a model parameter, rather than calendar days, to provide improved predictions of a crop characteristic or maturity parameter. Accordingly, a model may employ environmental data or parameters, such as weather forecast data, in order to model future TSS content as a function of time. Further, various embodiments may relate to the use of different models between different triggers to predict TSS for each day as a function of the crop phenology stage or characteristic.

In accordance with yet other embodiments, a machine learning or artificial intelligence process or system may be employed to further improve models and/or predictions arising therefrom. For example, data acquired throughout or after a growing season (e.g. TSS content at harvest, crop yield, or the like), may be input into a machine learning process or system to hone or improve predictive models for subsequent growing seasons. Accordingly, reference values (e.g. TSS values corresponding to detected crop maturity levels associated with threshold values of first and second parameters) may be iteratively improved for crops and/or crop locations over time to further improve model predictions and therefore crop management practices exercised in response thereto.

In accordance with some embodiments, models may additionally or alternatively relate to predicting various other crop characteristics, non-limiting examples of which may include a crop grade or yield.

It will be appreciated that various crop management practices may be implemented based on various aspects of crop phenology assessed, in accordance with various embodiments. For example, while the embodiments of FIGS. 7A to 7C relate to timing a crop harvest based on a crop ripeness or TSS content, various embodiments may further relate to managing or operating a crop irrigation system in response to notifications generated by a crop phenology assessment system, as further described below.

Moreover, a crop phenology assessment system may further provide value in informing crop protection practices. For instance, crops such as almonds or cherries may be vulnerable to pests at or after specific phenological crop stages. For example, navel orange worms may lay eggs in almond crops once almonds have experience hull split. Similarly, spotted wing drosophila may lay eggs in cherries once cherries have become sufficiently soft. A crop phenology assessment system may therefore, in accordance with various embodiments, may improve crop protection process by providing an indication to a grower that a crop is experiencing a particular crop stage (e.g. hull split, becoming sufficiently soft for exploitation by pests), thereby improving timing and efficiency of pesticide applications to, for instance, disrupt pest behaviour. It will be appreciated that such aspects may be similarly applied with respect to management practices related to watering (or withholding water or other application), harvesting, or the like.

With respect to some crop management practices, such as crop irrigation, one may consider how various crops (e.g. almond trees) may progress through phenological stages based at least in part on a crop stress level, or crop status. A phenological assessment system or method comprising automatic operation of an irrigation system may therefore operate, not operate, or operate in accordance with a designated irrigation regime, the irrigation system so to induce a crop stress level corresponding to a preferred crop phenology, or timeline thereof. For example, if it is preferred to induce a high crop stress level in a later phase of almond phenology so to, for instance, induce hull split, an irrigation system may be controlled so to reduce irrigation upon detection of a threshold trigger related size-related crop phenology (e.g. trigger 522 of FIG. 5). Similarly, if less water is required by a grape crop during Stage I and/or Stage II of a grape phenology to maintain high crop yield, a crop phenology assessment system or method may recommend, or automatically implement, an irrigation regime wherein less water is applied to a crop, so to save the grower the expenses associated with irrigation without sacrificing harvested crop quality. Further, such a reduced regime may be maintained until, for instance, the beginning or ending of a lag phase is observed via monitoring of a first parameter related to daily crop recovery values, whereby an irrigation regime is then augmented so to improve a harvested crop quality.

Accordingly, it may be desirable for various crop management applications (e.g. irrigation, fertigation, protection, harvest, and the like) to monitor crop phenology through the lens of a crop stress level or like metric. At least in part to this end, various embodiments may additionally or alternatively relate to monitoring a crop phenology based at least in part on first and second parameters sensed, calculated, inferred, or otherwise designated, which are reflective or representative of a crop stress, status, and/or phenological state.

As noted above, for some conventional applications, the difference between the maximum and minimum sizes of a crop over the course of a day, sometimes referred to as the maximum daily shrinkage (MDS) of the crop, may be used in an attempt to infer a crop stress, where it is generally assumed that there is a correlation between MDS and crop stress. However, while potentially useful for some applications, the MDS of a crop relates to a daily value, which may, for some applications, provide limited value. For example, the MDS does may not inherently capture or accurately reflect trends (e.g. growth, shrinkage, maintenance of a size or stress level) in crop size over multiple days, as it, when taken alone, reflects only a range of crop sizes measured within the span of a day. Moreover, as a metric of a crop status, MDS is highly sensitive to environmental conditions that may not accurately reflect a crop status or phenology. For instance, irrigation practices or rainfall may lead to overly large or small values of MDS for a crop, regardless of the crop status or phenology on a particular day or days. For example, a large irrigation event or rainfall may result in a rapid increase in trunk size, followed by a large decrease after cessation of water uptake. This may result in a high MDS value, which conventional approaches may interpret as a day of high stress for the crop, when in reality, the opposite is true.

Similarly, a crop may exhibit a high degree of variability based on cloud conditions. For example, a low-stress crop experiencing a high degree of sunshine may exhibit a high MDS on one day arising from, for instance, a high degree of evaporation and/or evapotranspiration, while the same crop under a high degree of stress on a cloudy day may provide a relatively lower MDS value as relatively less water is lost through evaporation/evapotranspiration, despite the crop being generally highly stressed.

Conversely, MDS values may not reflect, or reflect sufficiently to effectively assess a crop status or characteristic, extended periods of stress on a crop. For example, an extended period of high stress may correspond with a general decrease in crop size over several days, weeks, or months. Monitoring of an MDS value, however, reflects crop size values only over the course of a day, and does not capture historical crop size behaviour indicative of stress, which may result in the overlooking of important and/or relevant crop behaviour.

Generally, such effects (e.g. variability, lack of ‘memory’ of size behaviour, sensitivity to environmental conditions, and/or the like) may reduce the effectiveness of MDS monitoring for assessing, for instance, a crop stress or other condition. Even in cases where a form of ‘memory’ is introduced within a conventional crop assessment system or method, such as by summing historical MDS values, or introducing a daily growth value in a conventional status or stress calculation, the general lack of reliability and/or variability in MDS based on environmental and other conditions tenuously related or unrelated to crop stress may limit the effectiveness of such approaches for, for instance, informing crop management practices.

Various embodiments herein described, on the other hand, provide for improved assessment of a crop characteristic (e.g. phenological state, status, stress, or the like) through monitoring of crop size and the determination of one or more parameters more reflective of the crop characteristic than MDS values. Accordingly, various embodiments, among other aspects, may provide for improved crop management practices, ultimately resulting in, for instance, improved crop yields, values, return on investment, or the like.

For example, and in accordance with various embodiments, there is provided various methods and systems for monitoring a crop phenology and/or characteristic, wherein a size measurement of a crop is acquired in a crop location over time. The crop size may be acquired by, for instance, a dendrometer or like sensor, which may in turn comprise a band dendrometer, a point dendrometer, or a like device, that may be configured on or in association with a crop in a crop location to assess a size or dimension thereof, such as a trunk or stem diameter or radius, a berry size, or the like.

For greater clarity, various aspects of embodiments herein described with respect to an exemplary data set in Table 2 of crop size measurements and associated exemplary calculated parameters, in accordance with some non-limiting embodiments. It will be appreciated that such data is described for exemplary purposes only, and the that values are not necessarily representative of actual crop size measurements, and may employ arbitrary units that are not necessarily representative of actual units of measurement for real crops or sensing devices (e.g. dendrometers).

For the interpretation of Table 2, one may consider that a crop is assessed using a dendrometer, which has monitored and reported for digital storage trunk size values acquired over the course of, for instance, a growing season (e.g. every minute, every 10 minutes, every hour, or the like, over, for instance, 100 days of a growing season), although only a limited number of measurements are provided in Table 2 for clarity. For the purposes of discussion, it will be assumed that a newly acquired or calculated value occurs at period 0, while negative values of periods reflect hypothetical historical values, and positive values are hypothetical future periods to illustrate various exemplary calculations. Further, while Table 2 illustrates exemplary calculations to determine two different exemplary first parameters that may be employed in assessing a crop at a crop location, it will be appreciated that various alternative calculations performed in accordance with the systems and methods herein described may be similarly be applied with crop size measurement values, in accordance with other embodiments. For example, other columns of Table 2 (e.g. Seasonal Max, Periodic Max) may be considered as a first parameter used to determine a second parameter representative of a crop characteristic, in accordance with some embodiments.

TABLE 2
Exemplary Crop Data and Parameter Calculation

| | | | 1st | | | | | | 1st | | |
|---|---|---|---|---|---|---|---|---|---|---|---|
| | Periodic | | Param. | Periodic | Periodic | | | Seasonal | Param. | 2nd | |
| Period | Max | AVG | No Atten. | Min | Growth | Attenuation | Bracket | Max | Atten. | Param. | MDS |
| −6 | 16 | | | 12 | | | | | | | 4 |
| −5 | 17 | | | 15 | 1 | | | | | | 2 |
| −4 | 25 | 16.5 | 16.5 | 14 | 8 | 0.8 | NA | 16.5 | 16.5 | 2.5 | 11 |
| −3 | 16 | 16.5 | 16.5 | 15 | −9 | −0.9 | −0.5 | 16.5 | 16.5 | 1.5 | 1 |
| −2 | 19 | 17.5 | 17.5 | 16 | 3 | 0.3 | NA | 17.5 | 17.5 | 1.5 | 3 |
| −1 | 17 | 16.5 | 17.5 | 16 | −2 | −0.2 | −0.2 | 17.5 | 17.3 | 1.3 | 1 |
| 0 | 20 | 18 | 18 | 16 | 3 | 0.3 | NA | 18 | 18 | 2 | 4 |
| 1 | 16 | 16.5 | 18 | 14 | −4 | −0.4 | −0.3 | 18 | 17.7 | 3.7 | 2 |
| 2 | 16 | 16 | 18 | 14 | 0 | 0 | −0.2 | 18 | 17.5 | 3.5 | 2 |
| 3 | 15 | 15.5 | 18 | 14 | −1 | −0.1 | −0.1 | 18 | 17.4 | 3.4 | 1 |

From the exemplary data of Table 2, exemplary crop size measurement values are represented by the Periodic Max (and Periodic Min) column, which may correspond to, for instance, daily maxima (and daily minima) observed over a growing season. However, more generally, systems and methods may relate to the monitoring of a first parameter periodically calculated based at least in part on a periodic maximum value and a plurality of previously acquired periodic maximum values of the acquired size measurement, wherein the first parameter is calculated in accordance with a designated time window. That is, in some embodiments, the calculation of a first parameter may relate to, at least in part, the monitoring (e.g. the measurement, calculation, inference, digital storage, and/or the like) of a maximal value in size, determined on a daily or other periodic basis, wherein the periodic maximal value (e.g. daily maximum value 314) is compared and/or used in a calculation with previously observed and/or stored maximum period values (e.g. previous daily maxima 310 and 312), observed and/or stored over a designated historical time frame (e.g. daily maxima observed over the previous 2 days, 4 days, week, 10 days, month, 300 days, the previous year, or the like).

In accordance with some embodiments, such a calculation may relate to, for instance, a calculation of the average or like metric of a plurality of such periodic maximal values. For example, the calculation of a first parameter may relate, at least in part, to the calculation of the average value of daily maxima over 2, 3, 4, 5, 10, 30, 300, or the like, days. Otherwise stated, the calculation of a first parameter may relate, at least in part, to the calculation of an average value associated with observed daily maxima over a time window corresponding with time duration of any value between 2 to 5 days, 3 to 10 days, 5 to 15 days, 3 to 30 days, 4 to 400 days, or the like. In the exemplary embodiment of Table 2, periodic maxima may comprise maxima in trunk size, while subsequent calculations consider, in this non-limiting example, a designated time window of three days (i.e. a current maximal value and values from the previous two periods). It will be appreciated that a designated time window may correspond with a designated historical or seasonal time window (e.g. each corresponds to a time span of 3 days, 4 days, 7 days, 30 days, or the like), or may these time windows may correspond with different time spans (e.g. a designated time window may correspond with a time span of 1 week, while a designated seasonal time window may relate to a time span of 30 days, 100 days, 300 days, or the like).

In some embodiments, the calculation of a first parameter may relate, at least in part, to a function, average, percentile, or like metric, computed based on a subset of the set of maximal values acquired or calculated over the designated time window. For example, and without limitation, the calculation of a first parameter may perform a calculation using a subset of daily maxima of a crop size over a designated time window (e.g. 3 days, 4 days, a week, a year), while omitting some values of the set from the calculation. Accordingly, while the corresponding column of Table 2 is labeled ‘AVG’, it will be appreciated that various forms of averages, means, percentiles, or other statistical metrics may be reported and/or monitored.

For instance, and in accordance with one exemplary embodiment, the calculation of a first parameter may relate, at least in part, to the consideration of all daily maxima within one, two, or three standard deviations from the mean of a distribution of a maximum daily values observed over a week, or month, or other time span. In accordance with another embodiment, the calculation of a first parameter may relate a designated metric (e.g. average) of a subset of maximal values that excludes a designated number, fraction, or percentile of the highest periodic maximal values (e.g. the top 10% of daily maxima, the top 20% of daily maxima, or the like) over a designated time window. This may assist in, for instance, mitigating or eliminating skewing or other effects of extreme values in an average, mean, or other metric arising from external events, such as, for instance, irrigation events, rainfall(s), or the like, which may otherwise inflate maximal values without necessarily corresponding with or being reflective of a crop characteristic (e.g. stress, phenology, or the like). One such example is shown by the data in Table 2, wherein, of the three periodic maxima considered for any particular period, the highest value is omitted, with the remaining two periodic maxima considered for an updated average calculated periodically (i.e. AVG in Table 2). However, it will be appreciated that other embodiments may relate to the consideration of a different number of periodic maxima in the calculation of a metric related to periodic maxima (e.g. AVG in Table 2), such as four, five, seven, ten, thirty, or another number of values, and that another subset of data points may be considered for calculations, such as the bottom 50%, 80%, 90%, or the like of observed periodic maxima.

Similarly, yet further embodiments relate to the calculation of a first parameter based at least in part on a subset of maximal values that omits, from the set of maximal values acquired over a designated time window, a designated number, fraction, or percentile of the lowest maximal values (e.g. that omits the lowest 10%, 20%, or the like), which may similarly mitigate effects of irrigation, cloud conditions, the particular time within the period over which a maximal value is determined (e.g. the time of day defined as the beginning/end of a daily crop cycle) in view of irrigation and cloud conditions, or the like, of the maximal values acquired on the assessment of a crop condition.

In accordance with some embodiments, maximal values may be acquired or calculated periodically (e.g. daily, weekly, or the like), and stored (e.g. digitally) for future consideration and/or calculation. Accordingly, a first parameter may be calculated periodically as new maximal values are observed, as illustrated in Table 2, while considering in the first parameter calculation historical values over the designated time window (e.g. 2 days, 4 days, a week, 300 days, or the like). As such, a first parameter may, at least in part, relate to a calculation, comparison, or the like, over a rolling time window that is updated in accordance with the designated period of measurement (e.g. daily, weekly, or the like).

In accordance with some embodiments, a calculation of a first parameter may additionally or alternatively comprise a comparison with historic and/or previously calculated maximal periodic values, previously calculated or historic first parameter values, or the like, over a same, similar, or alternative time window, such as a seasonal time window (e.g. a growing season, a year, a designated number of days, such as 50 days, 100 days, 200 days, 300 days, or the like). For example, in Table 2, an exemplary first parameter calculation (1st Param. No Atten. In Table 2) relates to comparing each AVG value calculated for each period in consideration of a current maximum and two previous maxima, wherein the first parameter is deemed to be the highest AVG value yet observed (e.g. within the growing season, or the like) and is retained as a first parameter. In accordance with yet other embodiment, a first parameter may relate to the most recently calculated AVG value, such as the average of a subset of periodic maxima within the designated time window.

For example, and in accordance with one embodiment, the calculation of a first parameter may begin with the assessment of newly observed daily maximum. The new daily maximum may be compared or used in a calculation with previously observed daily maxima over a designated time window (e.g. 3 days, 4 days, a week, a month, or the like), as described above with respect to the exemplary AVG column of Table 2. In another embodiment, this may relate to calculating an average of the daily maxima observed over the past week, including the newly observed daily maximum, wherein the highest and lowest values are omitted from the calculation of the average. In another embodiment, the calculation may determine the average of a percentage (e.g. 10%, 20%, 80%, 90%, or the like) of the highest values observed over the time window, or, in another embodiment, a percentage of the lowest values of periodic maxima. It will be appreciated that, in some embodiments, any such calculations may be repeated periodically, such as upon the observation of a new or subsequent periodic maximum, wherein the designated time window is shifted by a period (e.g. by a day, for daily maxima), thereby providing a rolling time window over which periodic maxima are assessed.

It will be appreciated that, in accordance with other embodiments, the calculation of a first parameter may rely at least in part on a comparison of a newly acquired/calculated first parameter, periodic maximum, or derivation thereof with previously calculated first parameters, maximal values, or derivatives thereof, wherein the calculation proceeds based on whether a recently observed or calculated periodic maximum or first parameter is equal to, greater than, or less that, a previously observed value, whereby a result of the comparison determines which of a plurality of calculation processes will ensue for the calculation of a new or updated first parameter.

That is, and in accordance with some embodiments, the result of a particular calculation performed using a plurality of maximal values may be used to determine a subsequent calculation process. For example, if the result of an average of periodic maxima over a time window were to increase upon the observation of a new, relatively high daily maximum, the result of that calculation may be used in computational process A. Conversely, if the result of the average were to decrease from a previous value, the result of the calculation may determine that computational process B will be subsequently used. Accordingly, and in accordance with some embodiments, a system or method as herein described may comprise a comparison of observed values or derivations thereof with previously acquired and/or calculated values, and/or values expected based thereon.

For example, and in accordance with some embodiments, calculated values related to periodic maxima (e.g. averages, percentile values, or the like) may alternatively or additionally be compared with historic values stored within a digital storage medium. For example, one embodiment relates to the comparison of a newly computed value relating to periodic maxima (e.g. AVG) with a more ‘global’ or longer-scoping value, such as the maximum value of those computed over a designated seasonal time window (e.g. over the past 50, 100, 300, or the like periodically calculation values or parameters). For example, in Table 2, the Seasonal Max column corresponds with a comparison of each new average of periodic maxima (AVG) with a previously determined maximum value (e.g. Seasonal Max), and maintains the highest value of the comparison moving forward over the course of the season.

In some embodiments, the result of such a comparison may be used to determine subsequent calculation processes. For example, if the result of a calculation related to a subset of daily maxima upon acquisition of a new daily maximum results in a value that is the highest observed over a season (e.g. as is observed days −2 and 0 in Table 2), a process or system may then execute computational process A, which employs the newly calculated value related to the periodic maxima (e.g. the new average or percentile of daily maxima over a designated time window, AVG in Table 2, or the like). Conversely, if the result is equal to or lower than the historical or seasonal highest value, the process or system may relate to the execution of computational process B, which employs the previously determined highest value, another preceding value (e.g. the previous period's value), or a derivative thereof (e.g. a previous value having a mathematical function applied thereto), such as the first parameter calculated during the period immediately prior to that associated with the new periodic maximum.

For example, with respect to the exemplary calculation of a first parameter in Table 2 (i.e. 1^{st} Param. Atten.), a system or process compares a periodic value related to periodic maxima (e.g. AVG) with the Seasonal Max observed over the growing season. If the periodic value is equal to or higher than the Seasonal Max, the first parameter is updated as the periodic value (e.g. Computational Process A). Conversely, if the periodic value is less than the Seasonal Max, then a different computational process (e.g. Computational Process B) is applied to determine the first parameter for that period.

For example, in the latter case, a process or system may execute Computational Process B by subtracting a designated adjustment value from a previously observed or calculated parameter (e.g. the previous first parameter value), the result of which may be used in subsequent calculations, such in calculations performed during subsequent periods as new maximal values are acquired. In accordance with some embodiments, such a designated value that is subtracted may relate to various values associated with the crop being assessed, such as a periodic growth value (e.g. the difference between two consecutive daily maxima or minima, or some other characteristic value, such as the values of the crop size measurement acquired at a particular time over consecutive periods, or the like).

For example, in Table 2, the designated value subtracted from the previous period's first parameter relates to the daily growth of the crop, observed from periodic maxima, although it will be appreciated that other metrics may be similarly employed. In this example, the Periodic Growth column of Table 2 (e.g. the daily growth, th difference of a newly observed maximum and the previous maximum, or the like) is mapped to a designated adjustment value to be applied to the first parameter, in this case corresponding 10% of the growth value, to a minimum of −0.5 and a maximum of −0.2 (Bracket column in Table 2). For example, during Period −3, while a Periodic Growth of −9 was observed, 10% of which corresponds with Attenuation of −0.9, the Bracket value is −0.5, as this value was set as a minimum (i.e. greatest magnitude of a negative value) to be applied as an adjustment value.

In accordance with one non-limiting embodiment related to Table 2, the adjustment value of the first parameter is only applied when a new seasonal high of the metric associated with the plurality of maximal value is observed. Accordingly, days −2 and 0 do not relate to adjusting the first parameter from the average value, as there was a new seasonal high in AVG observed over those periods. However, it will be appreciated that other embodiments relate to other computational processes that may be employed to calculate or attenuate a periodically calculated first parameter. For example, as described above with respect to the calculation of a value associated with periodic maxima observed over a designated time window, a crop growth parameter (e.g. Periodic Growth in Table 2) may be similarly calculated based on a percentile or subset of periodic growth parameters acquired over a designated historical crop growth time window, such as a designated fraction (e.g. 10%, 50%, 80%, 90%, or the like) of the highest or lowest values of growth (which may relate to one or more of positive or negative values) observed over, for instance, a growing season, or a rolling time window.

While the previously described embodiment of Table 2 relates to a condition for updating a first parameter based on the observation (or lack thereof) of a new seasonal high, other conditions may be similarly employed. For example, the above noted embodiment may relate to attenuating or otherwise adjusting a first parameter value even when the crop is observed to grow over a given period, such as if the crop has experienced a daily growth, if the AVG value calculated is not a seasonal high. However, other embodiments may employ additional and/or alternative conditions related to the attenuation or adjustment of a first parameter (e.g. adjustment from an AVG or other value). For example, one embodiment relates to the evaluation of, in addition to the presence or absence of a newly observed a seasonal high in AVG, the crop is also observed to have experienced a periodic shrinkage (e.g. a negative daily growth value). It will be appreciated that other embodiments may consider additional or alternative conditions, or combinations thereof, in the determination of a computational process for calculating or monitoring one or more parameters.

Various embodiments may further relate to the determination of a second parameter calculated at least in part based on the first parameter. In some embodiments, this may relate to a calculation utilising a periodically calculated first parameter, and a minimal value of the size measurement over the corresponding period. For example, and with continued reference to Table 2, a second parameter (e.g. 2^{nd} Param. in Table 2) may comprise the difference between the first parameter (e.g. 1^{st} Param. Atten.) and a periodic minimum (e.g. Periodic Min), although it will be appreciated that other computations may be applied, and/or that various other first parameters may be employed in the calculation of a second parameter. Accordingly, in some embodiments, a second parameter may encompass an adjustment value based on, for instance, a periodically observed growth, which may be applied to either the first parameter (which may be used in the determination of a second parameter), the periodic minimal value, the second parameter itself, or a combination thereof, depending on the particular computational process applied.

In the exemplary embodiment of Table 2, exemplary second parameters are shown in the second-rightmost column of the table next to exemplary MDS values, which may be employed in conventional systems, calculated for the same data set. As will be further described below, MDS values, which is simply the difference between daily maxima and minima over the same period, can experience extreme variations (e.g. MDS of 11 in period −4), and, in this example, generally does not capture trends growth or stress trends in later periods (e.g. periods 1 to 3), while the second parameter generally exhibits high values during this time.

In accordance with various embodiments, a second parameter may be indicative of a crop characteristic, such as a crop stress, phenological state, or the like. For example, from the data of Table 2, wherein the exemplary crop generally decreases in size after approximately period 0, it may be determined that the crop is experiencing high stress. While the MDS values over that time are low, generally indicating low stress for the crop, the second parameter serves to indicate the high crop stress. Accordingly, various embodiments may thus relate to the provision of an indication related to a crop characteristic in response to a monitored second parameter. This may be useful in, for instance, informing crop management practices, such as irrigation, fertigation, protection, or the like. For example, as described above, various systems and methods may relate to the identification of a trigger or like value (or range of values) in, for instance, the second parameter, and provide a corresponding alert to a grower.

It will be appreciated that, depending on the particular application and/or computational process at hand, any parameter or value used in or resulting from a calculation to assess a crop characteristic or phenology may be compared with, or normalised by, a corresponding value or parameter expected for a comparable crop. For example, one or more of the first or second parameter may be normalised with a normalisation parameter corresponding to a previously determined value for a comparable crop experiencing or exhibiting a known or designated characteristic (e.g. well-irrigated, low-stress, or the like).

For example, in one embodiment, this may relate to normalising the second parameter, indicative of a characteristic of the crop being assessed, by a value associated with a similar crop (e.g. the same crop at a different time, the same crop species in a nearby or comparable location, one experiencing similar irrigation regimes, or the like) that is experiencing ideal or low stress, or is well-irrigated, given a particular environmental condition (e.g. low vapour pressure, high sunlight, or the like). Accordingly, in this non-limiting example, a second parameter may serve as an indication of a crop characteristic relative to an idealised or low-stress comparable crop in a similar environment. This may be achieved, in some non-limiting embodiments, as a ratio of the second parameter with a normalisation parameter, such as an MDS, first parameter, growth parameter, second parameter, or other characteristic of the comparable crop associated with the designated crop characteristic, thereby providing a relative indication of the crop characteristic. In accordance with some embodiments, such a normalisation parameter may be determined using, for instance, a regression fit of a plot of a designated parameter (e.g. MDS or the like) versus vapour pressure difference or like metric, wherein an expected value of the designated parameter may be inferred for the crop given an observed environmental and/or meteorological condition, as will be appreciated by the skilled artisan. Such a plot may be determined from, for instance, the same crop at different times when well-irrigated, and/or measurements performed on a similar crop/crop location.

Generally, and in accordance with some embodiments, a first parameter, in the context of some crop management applications, may be considered as a parameter that is in part representative of what a crop may be expected to experience as a daily maximum (e.g. rather than a daily maximum itself, as would be employed in the calculation of an MDS value). For example, and with reference again to Table 2, a first parameter may be represented by an average of periodic maxima over a designated time window, or a subset thereof (i.e. a first parameter may comprise the AVG column of Table 2, calculated periodically). Unlike an MDS calculation, which employs a single daily maximum, the use of a plurality of maxima in the determination of a first parameter considers a designated number of historical values, thereby being more representative of general and/or historical crop behaviour. In other embodiments, a first parameter may correspond, in whole or in part, to the maximum of such values observed over a designated historical seasonal time window (e.g. Seasonal Max column in Table 2), wherein it may be expected that a low-stress crop experience periodic maxima corresponding with historical maxima, as it is unlikely for a crop to naturally decrease in size in the absence of prolonged or extreme stress. In yet other embodiments, a first parameter (e.g. 1^{st} Param. Atten.) may be adjusted by a designated adjustment factor based at least in part on observed crop size behaviour (e.g. growth), thereby accounting for, for instance, periods of extended stress, wherein an ‘expected’ maximal crop size is adjusted from previous values based at least in part on other relevant crop behaviour. Such embodiments may, in contrast to conventional approaches employing an MDS value, retain memory of past crop behaviour, while also adapting to observed crop properties over time.

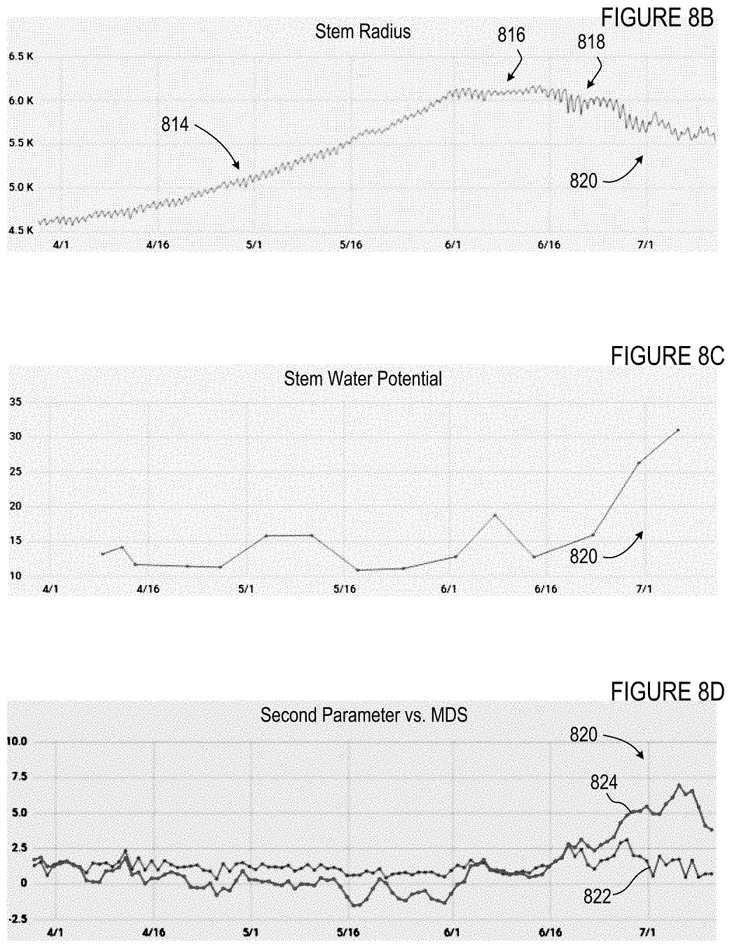

With reference now to FIGS. 8A to 8D, various aspects of the calculation of first and second parameters will now be described, in accordance with one non-limiting embodiment. In the example of FIG. 8A, a crop size measurement 802 is acquired over the course of a growing season. As described above with respect to, for instance, FIGS. 2 to 4D, the crop size 802, shown in FIG. 8A in arbitrary units, varies in accordance with an approximately periodic cycle (e.g. daily cycle) of growth and shrinkage, and accordingly comprises periodic maxima (e.g. maxima 310, 312, and 314) and minima (e.g. minima 316 and 318). Generally, this exemplary crop is seen to grow during early stages of the season (e.g. growth period 808), while it also shrinks during other times (e.g. time periods 810a and 810b).

In accordance with some embodiments, the exemplary plot of FIG. 8A further shows a plot of a first parameter 804 calculated periodically. As described above with respect to Table 2, the first parameter is calculated at least in part on an observed periodic maxima and previously determined periodic maxima within a designated time window (e.g. 3 days, 4 days, 7 days, 30 days, 300 days), which may omit one or more maxima from the calculation. For example, and as described above, the first parameter may be calculated in accordance with a designated percentile of data points corresponding to periodic maxima. Arising from the use of a plurality of data points, including historical values, the plot of the first parameter 804 generally lags a certain amount of time behind the raw crop size measurement 802 during general growth or shrinkage. For example, during growth period 808, the first parameter is observed to rise later than the corresponding trend in the crop size measurement 802, before approximately following the crop size measurement 802 during periods of relatively little crop growth.

It can further be observed from FIG. 8A that during periods of crop shrinkage (e.g. periods 810a and 810b), the first parameter decays. This is, as described above, a result of a first parameter calculation that considers general trends in crop behaviour, in this case a decrease in periodic crop size, or crop shrinkage. As described above, this may be manifested via the provision of an adjustment parameter calculated based on, for instance, a (negative) crop growth value, and an associated attenuation or adjustment factor that is calculated and applied to the first parameter when, for instance, the first parameter is not rising, and/or when a seasonal high in the first parameter and/or calculated function of the periodic maxima is not observed. Accordingly, and unlike an index (e.g. a global stress index) that would consider only a global maximum in crop size for consideration of, for instance, a crop stress, the first parameter is reflective of general trends experienced by the crop throughout the season.

Also observable in FIG. 8A is a plot of periodic minima 806 in the crop size profile 802. In accordance with some embodiments, the calculation of a second parameter may comprise, at least in part, a function of the first parameter and the periodic minima, calculated periodically. For example, in accordance with one embodiment, a second parameter, indicative of a crop characteristic, may be calculated as the difference between the first parameter 804 and the periodic minima 806, wherein the second parameter is indicative of a crop characteristic, such as a crop stress. In accordance with some embodiments, recognition or identification of particular or designated crop characteristic automatically calculated and recognised as, at least in part, a designated value, range or values, or the like of a second parameter, may be provided in the form of, for instance, a notification, a colour status, or the like, for instance via a smart phone or computer application, to thereby alert a grower as to the crop condition and/or a crop management recommendation with respect thereto, such as a recommendation to irrigate, fertigate, harvest, protect, or the like. In accordance with some embodiments, such an indication of a crop characteristic may result in the automatic application of a crop treatment, such as an automatically applied irrigation regimen via digitally controllable irrigation systems.

FIGS. 8B to 8D show further exemplary plots, each corresponding to the measurement and/or calculation of various parameters or metrics related to a same crop over a same time span, shown as a function of date on the x-axis of each plot. In this non-limiting example, FIG. 8B is a plot of the crop size observed over the season, similar to the crop size measurement 802 of FIG. 8A. In this case, the crop experienced a growth 814, followed by a plateau 816 in crop size, eventually followed by a decay 818 in crop size. While not necessarily applicable in all applications of embodiments herein described, the decay 818 of the crop size was induced for the crop so to induce a stressed crop characteristic. In some embodiments, assessment of such a stressed state, for instance during period 820, may assist a grower in managing crop practices, such as a harvest.

FIG. 8C shows a plot of the stem water potential of the same crop over the same time span as the plot of FIG. 8B. In accordance with some embodiments, an assessment of the stem water potential may be a direct or indirect measurement of crop stress, wherein a high stem water potential is indicative of and/or correlated with a high degree of stress. As expected from monitoring of the crop size in FIG. 8B, wherein the crop experienced a high degree of stress late in the season (e.g. region 820), the stem water potential rises during this time.

FIG. 8D is a plot of the MDS 822 and second parameter 824 for the crop over the same time span as the plots of FIGS. 8B and 8C. As noted above, the MDS 822 does not correlate well with the stress metric of stem water potential of FIG. 8C over the time span 820 when the crop was highly stressed. That is, it does not significantly rise in over the time span 820 when the stem water potential is highest. The second parameter 824, on the other hand, reflect the increase in crop stress during the time span 820, and provides a stronger correlation with the crop characteristic. Accordingly, and in accordance with various embodiments, a second parameter, calculated in accordance with the various systems and methods described herein, provides an improved means of assessing a crop characteristics, such as phenology, stress, or the like, as compared to conventional means.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1.-23. (canceled)

24. A method of monitoring a crop phenology, the method comprising:
acquiring a size measurement of a crop in a crop location over time;
monitoring a first parameter calculated based at least in part on one or more of a periodic shrinkage value of said size measurement or a periodic recovery value of said size measurement, and a second parameter calculated at least in part based on a periodic growth value of said size measurement, wherein one or more of said first parameter and said second parameter are indicative of a crop characteristic; and
providing an indication related to said crop characteristic in response to one or more of said first parameter and said second parameter.

25.-30. (canceled)

31. The method of claim 24, further comprising:
calculating, based at least in part on a phenological model, a predicted crop ripeness parameter for a future time, wherein said predicted crop ripeness parameter is related to said crop characteristic and said indication is provided in response to at least one of said first parameter, said second parameter, or said predicted crop ripeness parameter.

32. The method of claim 31, further comprising:
updating said phenological model based at least in part on a current crop ripeness parameter measured in accordance with a designated time associated with one or more of said first parameter or said second parameter.

33. (canceled)

34. The method of claim 24, wherein said indication relates to one or more of a yield estimation, a harvest time, an irrigation recommendation, or a crop ripeness.

35. The method of claim 24, wherein said first parameter is calculated as a function of the product of a designated number of one or more of said periodic shrinkage value or said periodic recovery value.

36.-39. (canceled)

40. The method of claim 24, further comprising:
generating a crop treatment recommendation based at least in part on one or more of said first or second parameter.

41. The method of claim 24, further comprising:
operating a crop treatment system based at least in part on said first or second parameter.

42. The method of claim 24, further comprising:
providing a crop treatment scheme for respective crop locations for respective crop locations based at least in part on said first and second parameters corresponding to said respective crop locations.

43. (canceled)

44. The method of claim 24, wherein said monitoring further comprises monitoring an environmental parameter, and wherein said indication is provided at least in part based on said environmental parameter.

45. (canceled)

46. The method of claim 24, wherein said crop characteristic comprises one or more of a predicted crop yield or a crop grade.

47. A system for monitoring a crop phenology, the system comprising:
a crop sensor operable to acquire crop size data of a crop in a crop location over time;
a digital data processor operable on said crop size data to calculate a first parameter based at least in part on one or more of a periodic recovery value or a periodic shrinkage value and a second parameter at least in part based on a periodic growth value, wherein one or more of said first parameter and said second parameter are indicative of a crop characteristic; and
an indicator system configured to provide an indication related to said crop characteristic in response to one or more of said first parameter and said second parameter.

48. The system of claim 47, wherein said crop characteristic is related to a phenological crop growth stage.

49. The system of claim 48, wherein said phenological crop growth stage is related to a crop lag phase.

50.-55. (canceled)

56. The system of claim 47, wherein said digital data processor is further operable to calculate a third parameter related to an extremum of said crop size data over said at least a portion of a growth season, wherein said third parameter is indicative of said crop characteristic, and wherein said indication is provided in response to one or more of said first, second, or third parameter.

57.-61. (canceled)

62. The system of claim 47, wherein said digital data processor is further operable to generate a crop treatment recommendation based at least in part on one or more of said first or second parameter.

63. The system of claim 62, further comprising a crop treatment system operable to apply a crop treatment based on said crop treatment recommendation.

64.-66. (canceled)

67. The system of claim 6647, wherein one or more of said first parameter or said second parameter is calculated based at least in part on said environmental data acquired by an environmental sensor.

68.-70. (canceled)

71. A method of monitoring a crop phenology, the method comprising:
acquiring a size measurement of a crop in a crop location over time;
monitoring a first parameter periodically calculated based at least in part on a periodic maximum value and a plurality of previously acquired periodic maximum values of said size measurement acquired within a designated time window, and a second parameter calculated at least in part based on said first parameter and a periodic minimal value of said size measurement, said second parameter being indicative of a crop characteristic; and
providing an indication related to said crop characteristic in response to said second parameter.

72. The method claim 71, comprising calculating, using a digital data processor configured to receive as input said size measurement acquired over time, a crop growth parameter corresponding at least in part to a characteristic periodic value of said size measurement, wherein said second parameter is calculated at least in part based on said crop growth parameter.

73. The method of claim 72, wherein said first parameter is calculated at least in part based on said crop growth parameter.

74. (canceled)

75. The method of claim 72, wherein said crop growth parameter is calculated at least in part based on a plurality of previously calculated crop growth parameters corresponding to a designated historical crop growth time window.

76. The method of claim 72, comprising digitally adjusting one or more of said first or second parameter by a designated adjustment value corresponding at least in part to said crop growth parameter.

77.-78. (canceled)

79. The method of claim 71, comprising digitally performing, using a digital data processor, a comparison of a current value of said first parameter with a previous value of said first parameter calculated over a designated seasonal time window, and, based at least in part on a result of said comparison, digitally updating said first parameter as said current value of said first parameter.

80.-92. (canceled)
